(19) United States
(12) Patent Application Publication
(10) Pub. No.: US 2007/0103104 A1
(43) Pub. Date: May 10, 2007

(54) Power torque tool

(76) Inventor: Lutz Axel May, Gelting (DE)

Correspondence Address: BLANK ROME LLP, 600 NEW HAMPSHIRE AVENUE, N.W., WASHINGTON, DC, 20037, US

(21) Appl. No.: 10/482,002

(22) PCT Filed: Jun. 24, 2002
(86) PCT No.: PCT/EP02/06960

§ 371 Date: Sep. 27, 2006

(30) Foreign Application Priority Data
Jun. 25, 2001 (GB) 0115494.7
Dec. 10, 2001 (GB) 0129511.2
Dec. 10, 2001 (GB) 0129509.6

(51) Int. Cl. H02P 7/00

(52) U.S. Cl. 318/432

(57) ABSTRACT

A power torque tool has an output shaft along which torque pulses are transmitted to a load such as a bolt. The shaft is driven by a mechanism which can be of the impact-type or piston-and-cylinder type. The torque in the shaft is measured by an integral region of the shaft which stores a remanent magnetisation which emanates a torque-dependent magnetic field. The field is sensed by non-contacting sensor arrangement. The torque impulses may be processed to control the operation of the primary motor so as to stop the motor when a predetermined torque is reached. The nature of the torque pulses generated in a power torque tool is analysed together with procedures for processing the pulses. The measurement of torque loss in torque pulse transmission along a shaft is disclosed.

### FIELD OF THE INVENTION

This invention relates to a pulsed torque tool and to methods for measuring the torque generated in such a tool and for controlling operation of the tool to achieve a pre-determined torque.

The invention also relates to a method and apparatus for measuring the torque loss occurring along a torque transmission shaft; and to the determination of the torque applied to a load by such a shaft. This aspect of the invention has particular application to the measuring of torque loss in a power tool generating a pulsed torque drive and to the determination of the torque applied to a load by such a power tool.

The invention has particular, though not exclusive, application to powered tools for delivering a controlled torque without the operator having to measure or judge the torque exerted. Such tools may sometimes be referred to as powered torque wrenches.

Pulsed torque tools include two categories. One in which an impact generates a torque impulse: the other in which a pulse of controlled characteristics is generated, such as by a pressure pulse generated with the aid of a piston and cylinder mechanism. In both cases, a train of successive pulses is generated to produce increasing torque. Impact-type tools may be electrically or pneumatically driven. Pressure pulse-type tools may be hydraulically-driven (e.g. oil) or electrically driven.

### BACKGROUND TO THE INVENTION

Power torque tools have been long used for applying a tightening torque to secure nuts to bolts, or similar operations, in manufacturing industry: automobile assembly is an example. They supply a succession of torque drive pulses. The pulses are generated at one end of an output shaft and are transmitted to an adapter at the other end configured to fit a nut or a bolt head. The pulses generated by power torque tools may be generally put in two classes in accord with the two categories of tool above mentioned.

The first class of pulses are short-duration impulses generated by impact power tools using a hammer and anvil type of mechanism in which a rotating hammer (dog) assembly percussively strikes an anvil coupled to the torque transmission shaft. This is an intermittent contact of hammer and anvil. A second class of pulses are longer duration impulses generated by pressure types of mechanism in which the shaft is continuously coupled to a piston and cylinder mechanism in which pressure pulses are generated to pulse the shaft. For convenience where a specific class of pulses is referred to herein the first and second classes of pulses may be referred to as impact pulses or impulses and pressure pulses or impulses, respectively.

As regards impact torque tools, reference may be made, for example, to U.S. Pat. Nos. 3,428,137 and 5,083,619. In such a tool a rotating motor, frequently pneumatically powered but it may be electrically powered, actuates with the aid of a cam a mechanism to drive hammer dogs in a linear axial direction and rotationally to engage anvil dogs whereby the rotational hammer motion transferred is to a rotary motion of anvil dogs as a step-wise pulsed motion. Usually there are two hammer impacts per rotation of the motor. The output shaft is driven by the step-wise pulsed motion of the anvil dogs. A clutch may be provided between the motor and the set of hammer dogs. Thus the anvil mechanism generates a train of torque impulses at the output shaft.

The delivery of torque to the shaft is not a simple relationship. It is very dependent on the nature of the load to which output torque is delivered. Tightening a nut up on a bolt or a bolt to a nut to a desired torque is a common example of a load and one much found in industrial assembly processes. In such industrial process it is often required that the same tightening procedure is repeated at frequent intervals and creates the need for a repetitive, reliable operation consistently achieving a required torque to which the nut or other part being tightened is driven. The torque is converted to other stresses by which the relevant parts or fixtures are secured.

It has been the practice to measure torque in the output shaft of an impact torque tool by means of a strain gauge assembly, the output of which is used to control the power to the motor. One problem with strain gauge sensors is that they are affixed to the output shaft. They are liable to become detached from the shaft due to the violent hammering and shaking of the shaft in an impact-type of operation. This is likely to be true of any sensor device that requires to be attached to the shaft. Another problem is the transmission of signals from the sensor device on the shaft to the processing electronics housed within the tool. The hammering and shaking of the shaft make the use of signal transmission by means such as slip rings unreliable. Yet another problem resides in the speed of response of the sensor device, or its related parameter bandwidth, bearing in mind that torque is generated as impulses in the shaft.

A more general problem which underlies the controlled operation of an impact torque tool is the lack of understanding to date of the torque impulsing and its interaction with the load which becomes stiffer as tightening progresses. If too high a degree of tightening is attempted, this may lead to damage, such as shearing of a bolt for example.

### SUMMARY OF THE INVENTION

The present invention proposes in one of its aspects the employment of magnetic-based torque transducer technology having a transducer element that is formed integrally in the output shaft of an power torque tool. By this means the transducer element cannot become detached from the shaft. The element emanates a torque-dependent magnetic field which is detected by a magnetic field sensor arrangement which is not in contact with the shaft. The transducer element is of a kind described further below which has a fast response appropriate to sensing torque impulses.

In another aspect the invention proposes procedures by which the achievement of a given torque can be predicted or measured and used in controlling the operation of a powered power torque tool. The development of these procedures depends on an investigation, analysis and measurement of the characteristics of the train of torque impulses generated by the tool. This work has now been undertaken with the aid of the magnetic transducer technology mentioned in the preceding paragraph and is reported below.

The practice of the invention will be more particularly described below in relation to an impact torque power tool and the processing of impact type impulses generated thereby. It will be understood that the employment of the magnetic-based torque transducer technology is applicable to tools generating pressure pulses. Furthermore the pulse processing and measurement procedures taught below are generally applicable to both impact and pressure types of pulses.

In a further aspect the present invention proposes to make a torque measurement at two points of known spacing along a torque transmission shaft to which pulses of torque are applied. This provides a measure from which can be deduced a parameter representing the torque loss or the rate (per unit length) of torque loss along the shaft, and from which parameter the torque delivered to the load end of the shaft can be calculated. In the description given hereinafter the torque loss per unit length along the shaft is considered constant so that a linear extrapolation can be made. However, the teachings herein can be applied to other assumptions of the torque loss per unit length.

This last aspect of the invention will be described and discussed hereinafter with particular reference to its implementation in relation to power torque tools.

Aspects and features of the present invention for which protection is presently sought are set forth in the claims following this description.

The invention and its practice will now be further described with reference to the accompanying drawings.

### BRIEF DESCRIPTION OF THE DRAWINGS

FIG. 1 shows diagrammatically the main features of a power torque tool being used to tighten a load in the form of a nut and bolt engaging a fixture. Torque is applied to the head of the bolt to tighten it with respect to the nut.

FIG. 2 shows diagrammatically an experimental laboratory apparatus using a pendulum to deliver a torque impulse to a shaft;

FIG. 3 is a view of the pendulum apparatus of FIG. 2 including a magnetic torque transducer;

FIG. 4 shows torque impulse responses derived from the transducer for a rigidly held shaft impulsed by different pendulum energies;

FIG. 5 shows torque impulse responses for a shaft that is stiffly but not rigidly held at different levels of stiffness and the same pendulum energy applied;

FIG. 6 is a set of diagrams A-F showing the nature of the impulsing as seen in FIGS. 4 and 5;

FIGS. 7, 8 and 9 shows impulse responses over a longer time interval for an impact torque tool for a bolt that is relatively lose, very tight and hard tight respectively;

FIG. 10 shows superimposed trains of torque impulses to illustrate the pulse-to-pulse variation when a mechanical adapter is used on an impact power tool;

FIGS. 11a-11c are presentations in a three-dimensional graphical form of a data relating to a sequence of impulses, the presentations being of the same data from different perpsectives with respect to the axes of the graphs;

FIG. 12 is a presentation in a three-dimensional graphical form in the perspective of FIG. 11c of data relating to a sequence of impulses having a different characteristic to that of FIGS. 11a-c;

FIG. 13 is a graph showing curves relating to a Signal Integration procedure;

FIG. 14 illustrates the shape of the curve showing the rise with successive impacts of torque in the output shaft of an impact torque tool, the measurements being performed on an oil-pressure chamber torque calibration unit;

FIG. 15 is a graph of the time interval between successive impacts over a train of impacts;

FIG. 16 illustrates parameters of a torque pulse train relevant to an Instantaneous Torque Calculation procedure;

FIGS. 17-19 are graphs relating to plots of various parameters measured and derived in the Instantaneous Torque Calculation procedure;

FIG. 20 is a graph showing the fit of a curve of FIG. 14 to the curve plotted in FIG. 19 to demonstrate a correlation between them;

FIG. 21 is a flow-type diagram illustrating the implementation of Instantaneous Torque Calculation or Signal Integration to a train of pulses;

FIG. 22a illustrates a representative sample of a train of pulses; and

FIG. 22b is a curve showing the resultant torque value at the load.

FIGS. 23a and 23b diagrammatically illustrate examples of impact and pressure pulses respectively generated by different types of power torque tool; and

FIG. 24 shows a transducer arrangement utilising two torque transducers in accord with the present invention.

### DESCRIPTION OF PREFERRED EMBODIMENTS

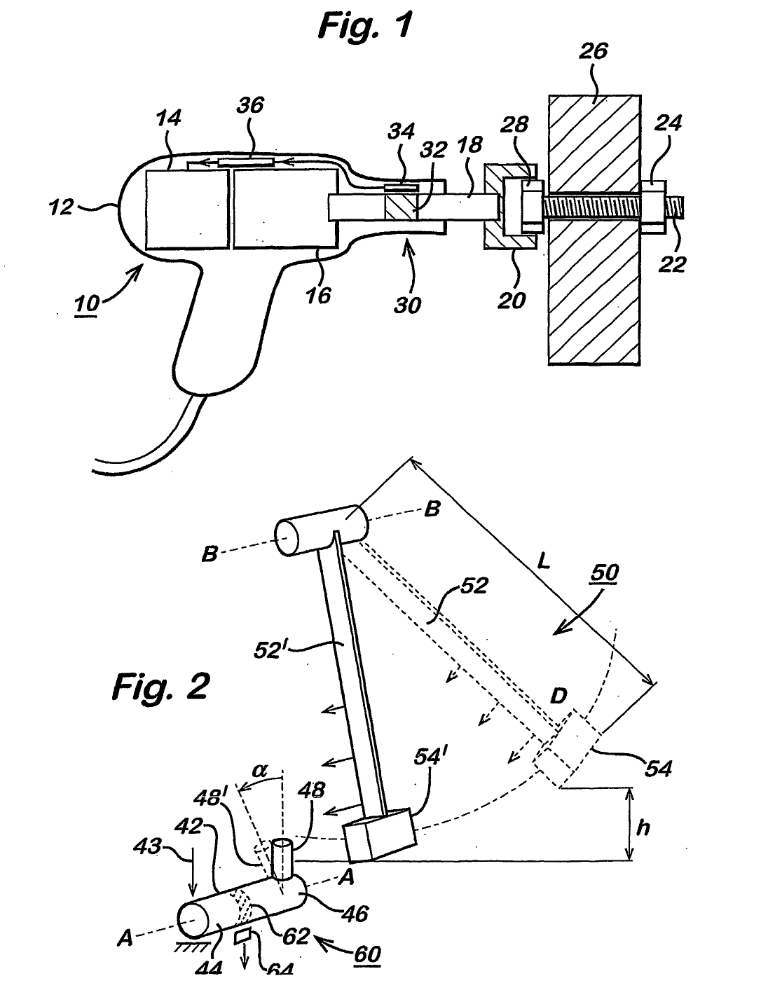

FIG. 1 shows diagrammatically elements of a power torque tool 10 to which the invention is applied. The tool may be of the impact pulse type or of the pressure pulse type but for the purposes of the description that now follows, the tool 10 is taken to be of the impact pulse type.

The impact torque tool 10 is illustrated as a hand-held implement having a housing 12 within which is an electrically or pneumatically powered motor 14. The motor is coupled by an impact converter 16 to an output shaft 18 the distal end of which carries an adapter 20 engageable with the load to which torque is to be applied. In this example, the load is a bolt 22 which carries a nut 24 and which extends through an apertured fixture 26. As shown the nut and bolt are being tightened on to the fixture 26. The adapter 20 engages the head 28 of the bolt, being formed with an internal recess that matches the head 28, e.g. an hexagonal head. The features of the tool 10 so far described are conventional and well-known to those in the art. As will emerge from subsequent discussion the impact converter, by which the rotation of the motor 14 is converted to a train of torque pulses in the shaft 16, the transmission of those pulses to the bolt head 28 has been the subject of a new investigation yielding new information as to the manner in which the torque impulses are generated, transmitted and react with a tightening load, that is a load which progressively yields less as the tightening proceeds. In all the tests described below the shaft or bolt to which torque is applied is being stressed within its mechanical elastic limits to avoid permanent deformation of which shear or breakage is the extreme end-point.

A new feature of the tool is a magnetic transducer 30 by which the torque impulses in the shaft are detected and measured. The transducer comprises a torque-sensitive element 32 which is an integral region of shaft 18 which is assumed to be of ferromagnetic material. The region 32 is magnetised to have remnant or stored magnetisation so that it acts as a source of external magnetic field, the magnetisation being effected in such a way that the region 32 emanates a magnetic field or field component which is dependent on the torque. One form of magnetisation is circumferential (circular) magnetisation the employment of which in an integral region of a shaft is disclosed in WO99/56099. Another form of magnetisation usable in an integral region of a shaft is longitudinal magnetisation in which an annulus of stored magnetisation is formed about the axis of the shaft and the magnetisation is in the direction of the shaft. One kind of longitudinal magnetisation is that referred to as circumferential sensing and is disclosed in published PCT application WO01/13081, and another kind, referred to as profile shift magnetisation, is disclosed in published PCT application WO01/79801, incorporated herein by reference. The profile shift may be detected in respect of the radial or the axial profile. The documents just-mentioned describe the magnetic sensor arrangements appropriate to the field to be detected. The present invention has been developed, and the investigations reported below have been made, using a profile shift magnetisation kind of transducer element. The emanated torque-dependent magnetic field is detected by a non-contacting sensor arrangement 34 which is connected to a detector and control circuit 36 which in turn controls the operation of the motor 14. The sensor arrangement may comprise more than one sensor device and further details of the nature of the emanated magnetic field and the placement of the one or more sensor devices is to be found for each form of magnetisation in WO99/56099, WO01/13081 and WO01/79801 above-mentioned.

The sensor device(s) employed in sensor arrangement 34 may be Hall effect or magnetoresistive devices. What has been preferably used is saturating core device(s) connected in a circuit such as disclosed in WO98/52063.

In operating the impact torque tool—which may also be referred to as impact torque wrench—it is of interest to measure and predict the build up of torque in the bolt 22. The transducer built into the tool can only measure torque in the output shaft, though this torque will be affected by the tightness of the bolt. It is to be noted that the transfer of torque from the shaft 18 to bolt 22 depends on how well the adapter 20 seats on the bolt head 28 and the alignment between the axis of shaft 18 and the axis of bolt 22, bearing in mind that the tool is hand-held and may be applied with some misalignment. It has been found that the efficiency of torque transfer between the tool and the bolt is not likely to exceed 30%. Additionally losses can occur between the bolt 27 and the part or fixture 26 to which it is being secured. In the case where the bolt is a snug fit within the aperture through which it extends and is very rusty and not greased the torque transmission losses from the bolt-head 28 to the bolt shaft itself may be more than 50%. In using a hand-held tool the torque delivered over a series of impulses can vary widely.

There are a number of different approaches to defining how a pre-determined torque is achieved in the load being tightened. The bolt previously discussed will be used as an example.

1) Signal Integration

This method is based on measuring the torque delivered with each impact and integrating successive measurements to predict the achievement of a required torque within the shaft of the bolt. The method requires a calibration of the complete system of tool and load for which the bolt previously described will be used as an example. The measurement cycle begins from the point at which the bolt is just tightened to the part as by hand-tightening the bolt. At this point the torque in the bolt shaft is essentially zero.

This method assumes that the bolt-tightening under the action of the impact torque tool proceeds without interruption. It is applicable when the increase in torque with successive impacts on the bolt-head follows a defined curve that will be explained subsequently.

2) Instantaneous Torque Calculation

This method is also applied to the complete system of impact power tool and load. It relies on analysing the torque signal detected at each impact and calculating a torque dependent parameter for each impact. The succession of parameter are matched to a defined curve of torque v the number of the impact in a train of impulses.

The two procedures can be made available in a program operating in real-time and the program can include a decision function for selecting one or other procedure upon certain characteristics being detected as will be explained subsequently.

Both the above methods arise from work newly-done to investigate the impulse-type of action and the torque impulse arising out of it.

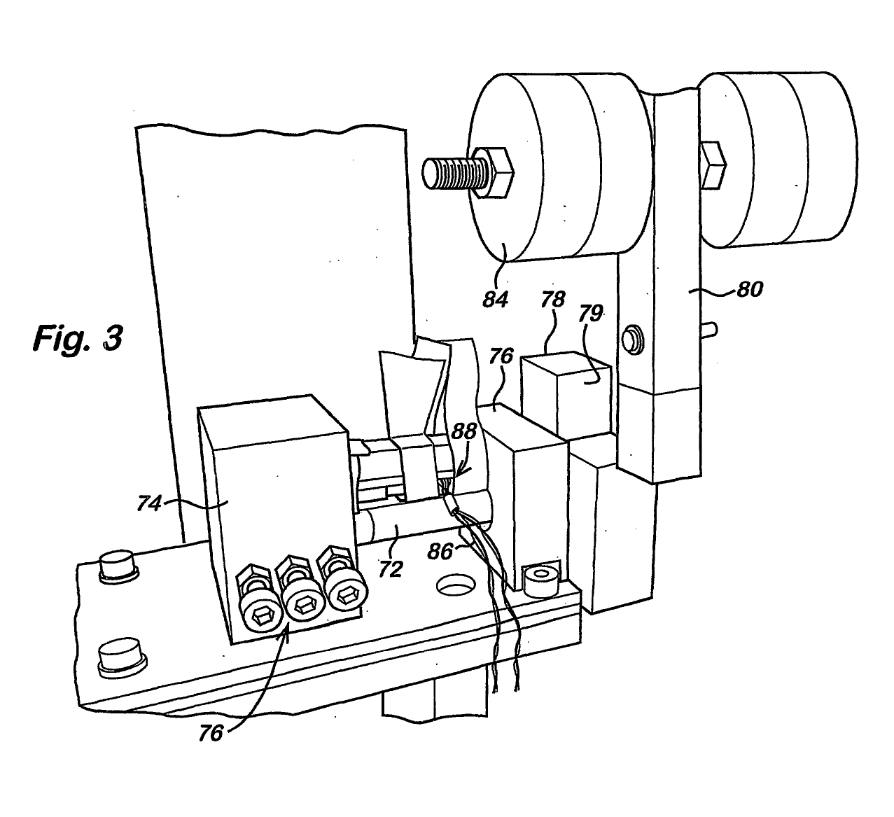

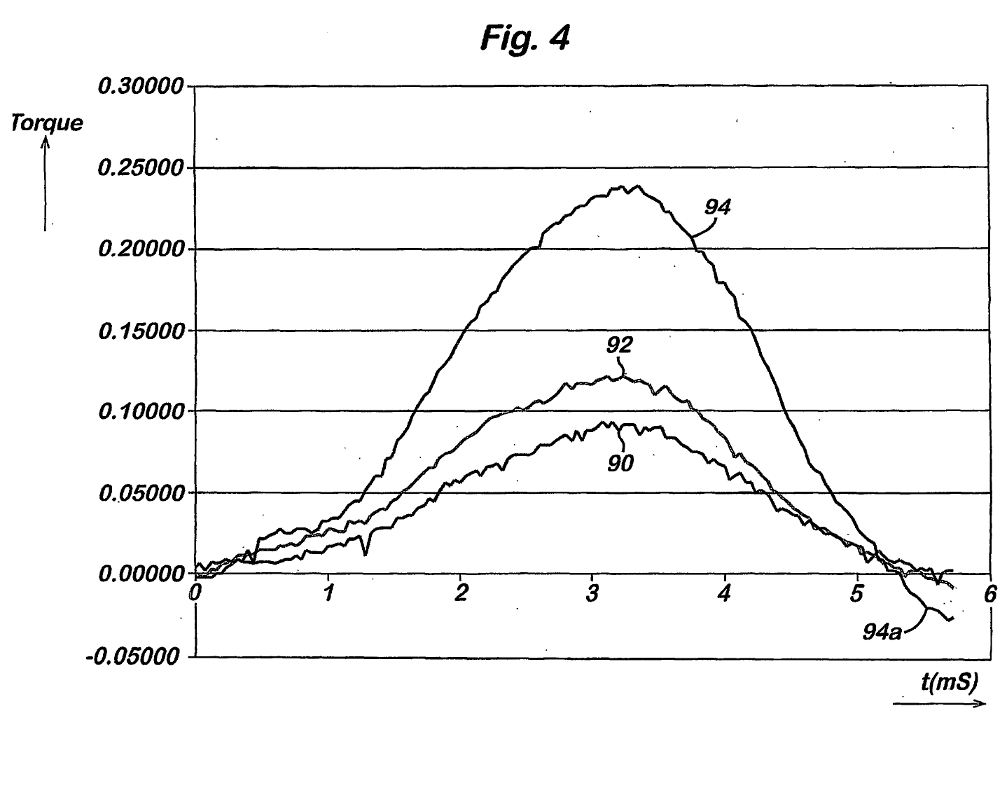

FIG. 2 diagrammatically illustrates the principle of a laboratory apparatus to investigate impact torque generation. A practical implementation is seen in FIG. 3. Referring to FIG. 2 a shaft 42 has one end 44 clamped against rotation in a fixture schematically shown as 43. The fixture includes an aperture for receiving the bolt end 44 into which extends a clamping screw which can be adjusted from a setting allowing virtually free rotation of shaft 42 about its horizontal axis A-A, through degrees of resisted rotation, to no rotation. The other end 46 of the bolt is provided with a radially projecting peg 48 acting as an anvil. A pendulum 50 mounted to swing freely about horizontal axis B-B above axis A-A has a pendulum arm 52 carrying a weight 54, the pendulum being dimensioned so that as it swings downwardly from a raised position the weight 54 strikes the peg 48 to generate a torque-energy impulse on shaft 42 from the momentum of the weight. The energy available to each torque impulse is determined by the initial height of the weight 54. FIG. 2 shows two initial positions 52 and 52′ of the pendulum arm and the weights 54, 54′ thereon, the height between which is h. Upon impacting the peg 48 it is deflected about axis A-A by an angle α shown exaggerated for clarity of illustration. The deflected peg position is 48′. The torque impulse in the shaft 42 due to the impact is measured by a magnetic-based transducer 60 comprising integral transducer region 62 of shaft 42 and sensor arrangement 64 in accordance with the transducer assembly 30 previously described. By way of example, the length L of the pendulum was 1.10 m, the weight 54 had a mass of 2 kg and the shaft 42 was of tensile steel of 15 mm diameter which is close to the diameter of the output shaft of the kind of specific input torque tool described below. The torque impulses detected by the transducer 60 are output as corresponding electrical signals and were monitored and displayed both as to duration and amplitude. The overall shape is also of significance.

FIG. 3 shows a practical laboratory apparatus working on the principle of FIG. 2 and on which the results now to be reported were obtained. In FIG. 3, one end of the shaft 72 is secured in apertured block 74 in which adjustable bolts 76 are threadedly received in the block to act on shaft 72 and thereby control the degree of restraint against rotation. The other end portion of the shaft is rotatably mounted in support block 76 and the far end, projecting from block 76 carries the anvil 78 having a strike face 79. The Figure also shows the lower end of the pendulum arm 80 carrying a hammer 82 about to strike face 79. Weights 84 are secured to the pendulum. The magnetic field emanated by transducer region 86 in the shaft is detected by sensor arrangement 88.

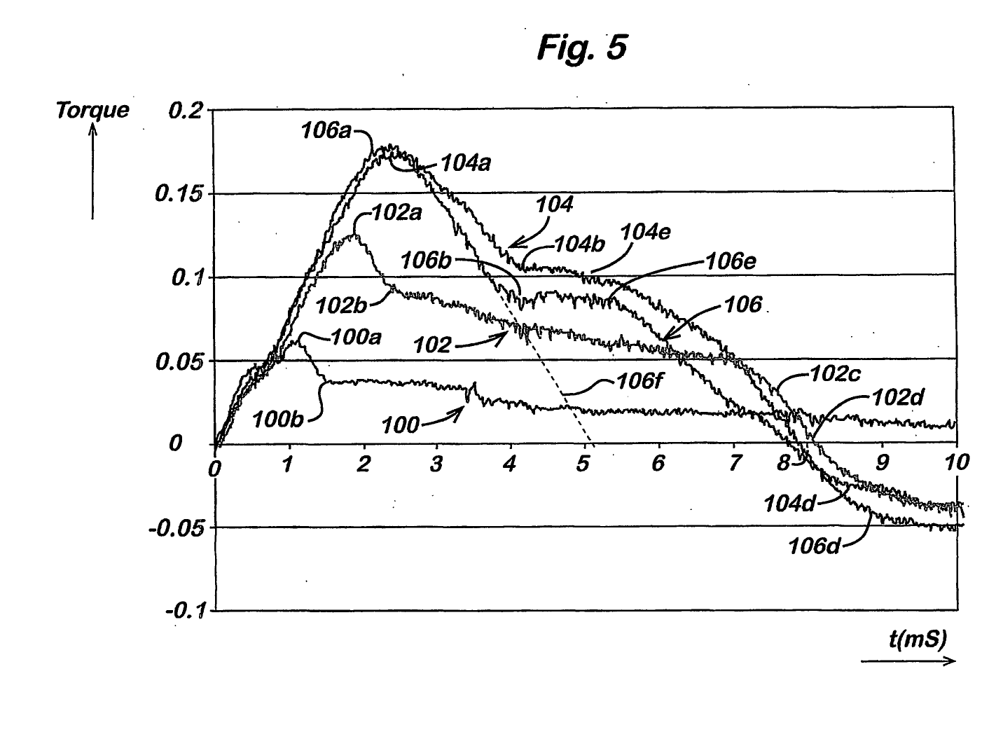

The first set of tests were performed with the shaft 72 held rigidly in block 74. These are shown in the curves of FIG. 4 in which the ordinate axis is the voltage output of the torque transducer 80 representing torque, and the abscissa axis is elapsed time in seconds, specifically gradations in milliseconds. The graph shows three curves 90, 92, 94 for different pendulum impulses for which initial height h of the hammer 82 above the strike position against face 79 was 17.4, 47 and 67 cm respectively. The torque pulse in each case is of a generally similar form—the torque rises, peaks, and then falls. The peak value rises with the increasing pendulum energy. No rotation of the shaft results. Curve 94 shows the end of the pulse swings below zero on the downslope as indicated at 94a. This negative swing or rebound has a significance that will emerge later with reference to figures that have an extended time axis. It will be noted from FIG. 4 that the pulses are generally symmetrical and have the same positive pulse duration.

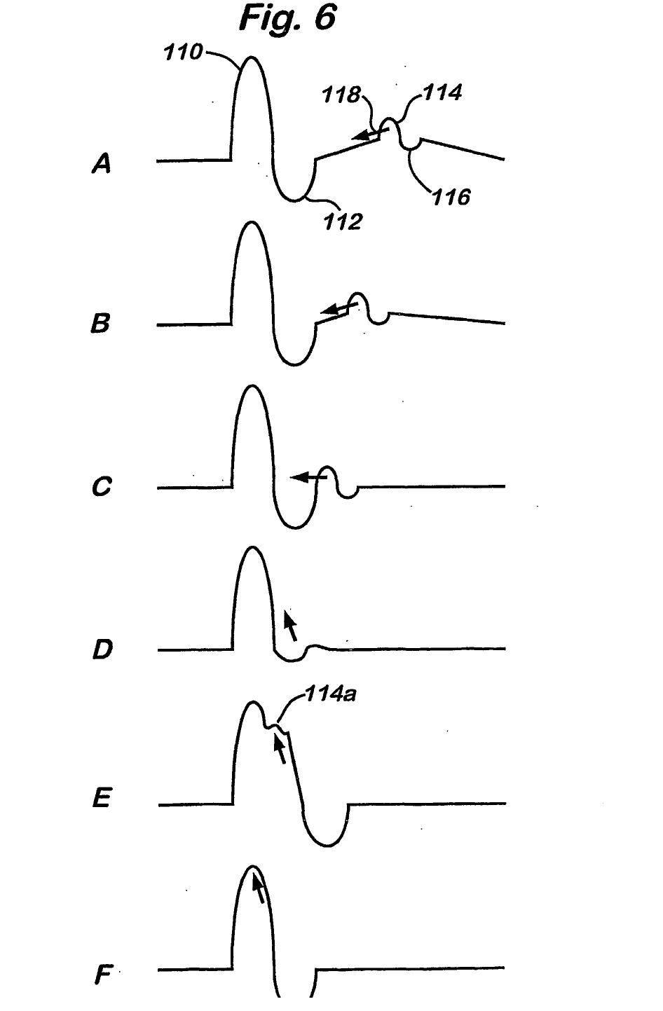

Referring to FIG. 5, the graph shown is of the same kind as FIG. 4 but the applied conditions are different. The pendulum strikes with the same energy, i.e. is raised to the same height in each case but the restraint on the shaft against rotation is varied. The bolts 76 have been released a little so that the shaft 72 is jammed but is capable of turning. It is again emphasised that the shaft 72 under test is operating within its elastic limits. The time axis in FIG. 5 is also extended as compared to FIG. 4. Curves 100, 102, 104 and 106 are for increasing degrees of rotational restraint. All the four curves start to rise at essentially the same rate reflecting the same impact energy from the pendulum. The curve 100 pertaining to the lowest restraint against rotation rises to a peak 100a at which the shaft commences to turn at which time the applied torque drops rapidly to a lower value 100b and then tails off slowly, as the shaft turns and the impact energy is expended. There is no rebound. In this case the shaft 72 can be regarded as being pushed by the torque generated by the pendulum throughout the period the shaft turns. This is also true of the other curves.

Curve 102 requires more torque (102a) to commence rotation of the shaft. The torque then drops to a level 102b and then tails off in value during a period in which rotation continues, until the torque at 102c is no longer sufficient to maintain rotation at which time there is a sudden drop into a rebound phase 102d in which the torque reverses (becomes negative).

Curve 104 is for a still greater restraint against rotation. It reaches a higher peak 104a than that of curve 102, descends rapidly to a value 104b from which it declines further to a zero value by which time rotation of the shaft has creased, and enters a rebound phase 104d. The decline period shows the hint of a small rise at 104e after the peak has descended to 104b. Curve 106 is a case where the shaft is now very light against rotation but is not hard tight to prevent any rotation. The peak value 106a reached is virtually the same as that of curve 104. There is a descent quicker than curve 104 to a value 106b which is followed by a distinct rise 106e before the trailing decline into the rebound phase 106d.

There are some time relationships which should be noted in FIGS. 4 and 5. It has already been mentioned that the positive pulse torque period for the three pulses is virtually the same at about 5 mS. In FIG. 5 the restraint on the shaft 72 for curve 106 is closely approaching the total restraint applicable to the curves of FIG. 4. If the descent from the peak 106a is extended as shown by dashed line 106f it intercepts the zero torque axis close to 5 mS as with the curves of FIG. 4.

In FIG. 5, it is also the case that where the curves show a rebound phase, i.e. 102, 104 and 106, they all cross the zero torque axis at virtually the same time, 8 mS. Thus the positive pulse portion driving the shaft 72 to rotation has the same total length in each of these cases.

One factor that is not directly seen from the curve of FIG. 5 is the speed at which the shaft rotates and strike face 79 moves relative to the hammer 82 in (FIG. 3). Also in tightening up a bolt with an impact torque tool such as outlined above, the torque required for rotation increases as the bolt rotates and the delivery of the input energy may be different from the pendulum case. Nonetheless, the pendulum apparatus experiments provide valuable guidance as to further investigations to be undertaken with an impact torque tool itself. There is an indication in the curves of FIG. 5 that as the torque impulse trails away there is another effect that needs to be taken into account.

Referring to FIGS. 4 and 5, it is not surprising that where the shaft is held rigid against rotation, the peak torque impulse in the shaft increases with increasing pendulum energy and is followed by a significant rebound as the shaft relaxes. The pulses of FIG. 4 appear to indicate effectively a single strike of the anvil by the pendulum. FIG. 5 indicates something more complex in the pulse structure. Also FIG. 5 illustrates a situation which appears analogous to static friction (striction) and dynamic friction. There is a limiting friction required to be overcome before the shaft rotates, whereafter rotation continues at a lesser torque value until the torque reduces to a level at which rotation cannot be maintained. This is exemplified in the curves of FIG. 5. If rotation can be maintained for a period as in curve 100, it appears that all the impact energy is dissipated without a rebound pulse.

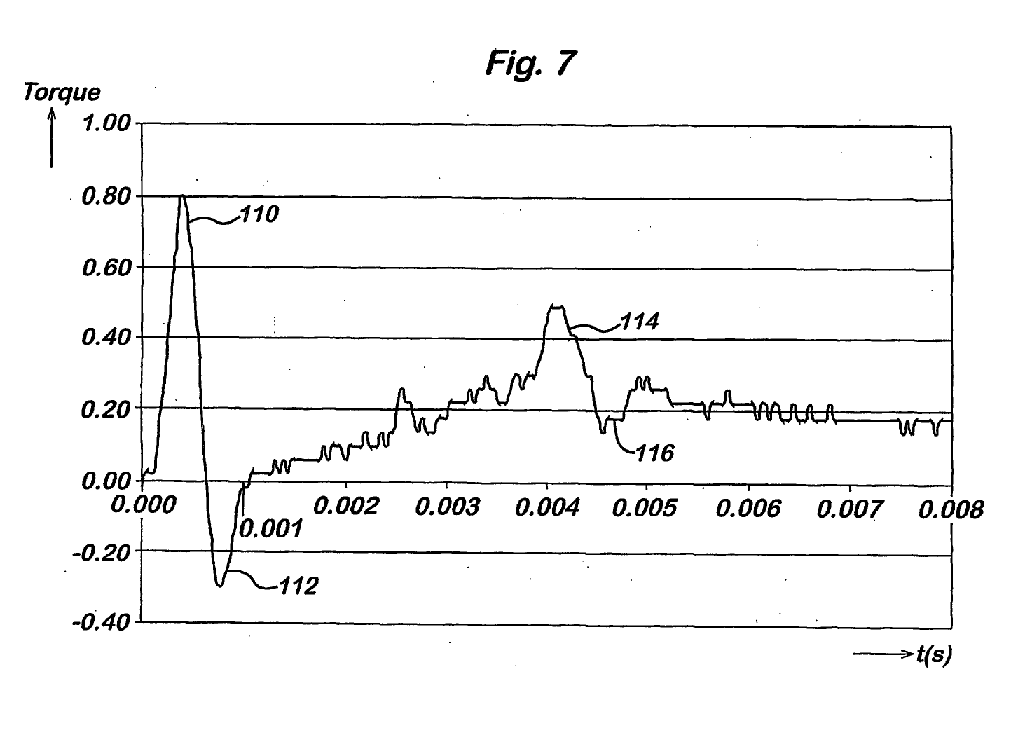

The following discussion is put forward as a theoretical explanation of a hammer action in an impulse torque tool based on the results seen in FIGS. 4 and 5. Reference will be made to the diagrams of FIG. 6 which illustrates six conditions A-F of a hammer striking the anvil in an impact torque tool tightening a bolt head 28 as in FIG. 1. Each shows the torque amplitude (ordinate) as a function of time (abscissa). Diagram A shows the bolt starting in a relatively loose state—e.g. hand tight. There is an first positive torque impulse 110 followed by a lesser amplitude negative rebound or recoil 112. In response to the positive impulse head 28 initially flies ahead of the hammer action but as the diagram shows there is a second impulse shown as a secondary peak 114 followed by a secondary rebound 116. In diagram A, the secondary impact is distinct from the primary impact. As the bolt tightens it requires more torque to turn it. The bolt both rotates less and for a shorter period so that the time between the primary and secondary impacts shorten. This is indicated by arrow 118 showing the secondary impulse advancing in time towards the primary impulse. This is the situation shown in diagram B. As the tightening continues, the secondary pulse moves still nearer the primary as in diagram C until as illustrated in diagram D, the secondary positive peak 110 overlaps the negative primary pulse rebound 112. This substantially flattens the negative swing and may cancel it altogether. As the bolt turns less and less on each impact the positive part of the secondary pulse occurs within positive part of the primary pulse moving steadily up the trailing edge. It is at this stage that the conditions applying to FIGS. 4 and 5 arise. The bolt head which has been flying ahead now enters the push mode above-mentioned. Diagram E shows the secondary pulse slightly lifting the trailing edge at 114a and as is seen at 104e in FIG. 5 and more so at 106e. Finally the bolt ceases to turn further and effectively the secondary pulse disappears or may be regarded as coincident with the primary pulse. There is a single impact which causes a torque pulse like that exerted in FIG. 4. The peak torque exerted is the same as in the earlier diagrams. This is considered to be consistent with curve peaks 104a and 106a′ in FIG. 5. It is, of course, to be remembered that the graph of FIG. 5 relates to the pendulum experiment, whereas the explanation given with reference to the diagrams of FIG. 6 assumes a rapidly and repetitively driven impact converter in a impact torque tool.

The theoretical nature of FIG. 6 was explored by some practical tests.

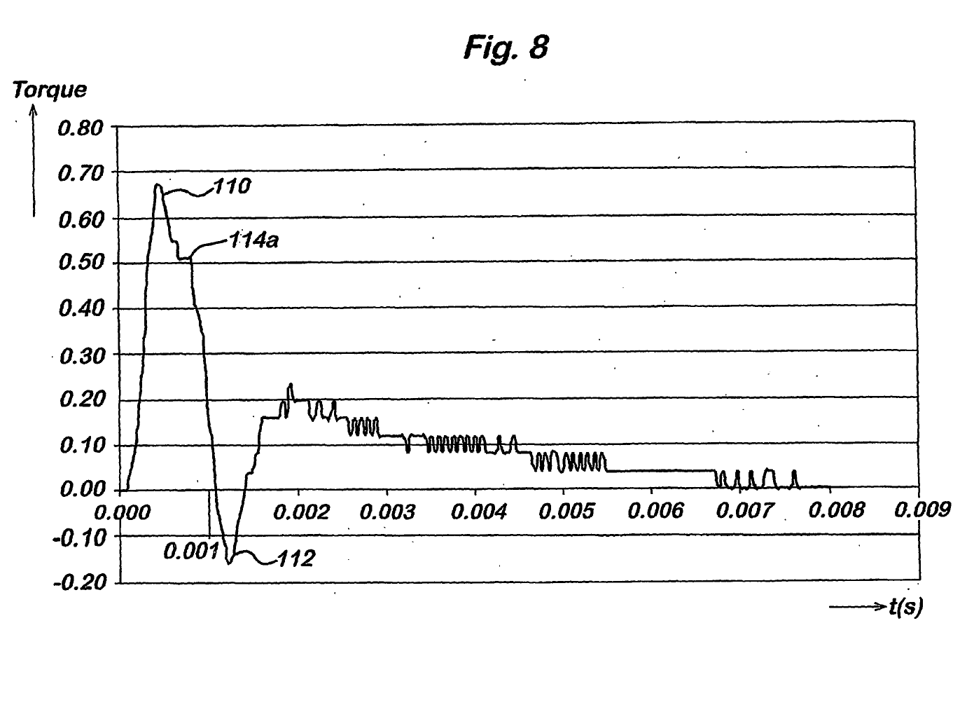

Using the tool equipped with a transducer 30 as shown in FIG. 1, investigations were made on the torque impulses generated in the output shaft 18 of the tool itself when driving a bolt load as illustrated. The tool used was a “CP733” pneumatically powered impact torque wrench available from Chicago Pneumatic Tool Company of Rock Hill, S.C. The results of these investigations are shown in FIGS. 7-9. Each figure is a graph of the transducer output representing torque as a function of time for a single impact in the converter 16 of FIG. 1. FIGS. 7-9 relate to different conditions of bolt tightness, loose (hand-tight), tight but still capable of a little rotation and hard tight respectively. The same reference numerals are employed as in FIG. 6 for the pulse portions like to those of FIG. 6.

FIG. 7 shows the first impact impulse 110 which is transmitted to the load (the bolt) which being relatively loose flies ahead. The output shaft 18 of the tool also initially flies ahead of the hammer mechanism in the tool going through a rebound 112 from which the torque rises positively as the shaft shows whereupon there is a second impulse 114 from the hammer mechanism which is followed by its own secondary rebound 116.

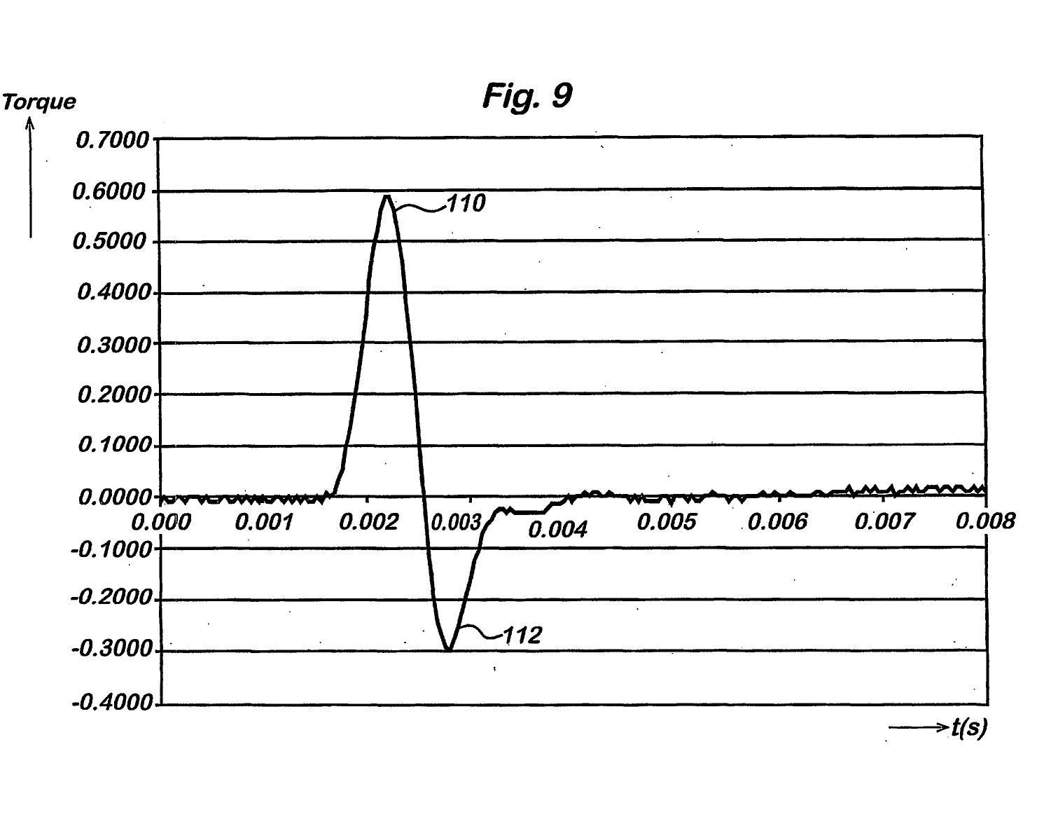

FIG. 8 relating to driving a very tight bolt, shows the situation as in Diagram E of FIG. 6 (and curves 104 and 106 in FIG. 5) in which the torque impulse reaches a value sufficient to slightly turn the bolt and the output shaft at which point the torque drops. By this stage, the secondary impulse has sufficiently advanced in time for the portion 114 to appear as a small peak 114a on the trailing part of the primary impulse.

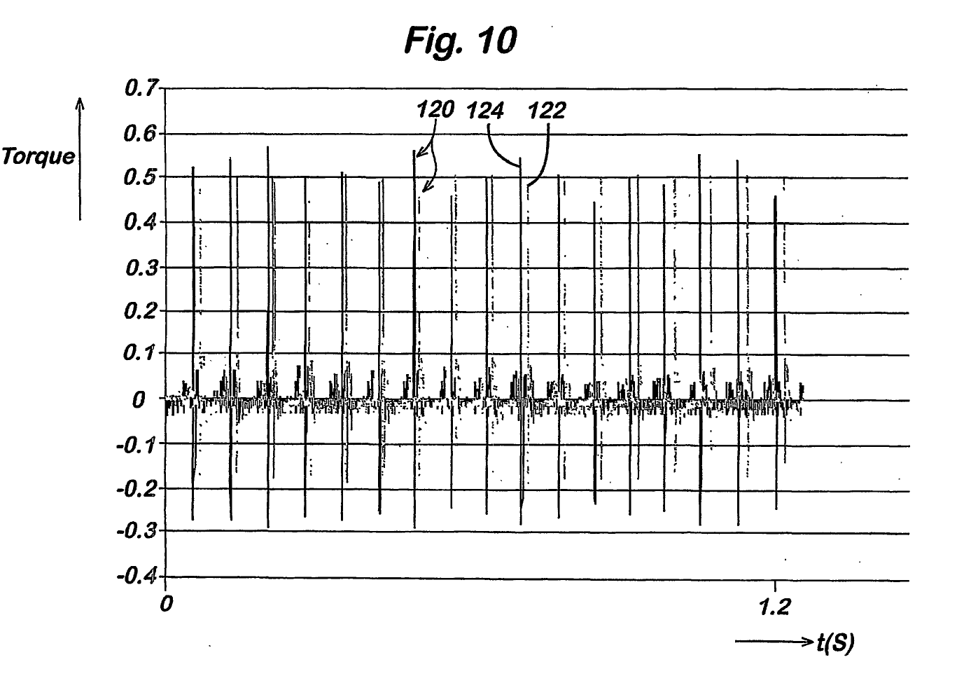

FIG. 9 shows the impulse waveform when the bolt being driven is hard tight. There is a peak value torque pulse 110 which does not move the bolt followed by a rebound 112. This is consistent with FIG. 1.

Attention is now turned to the more practical use of the investigations reported above in determining when a impact torque wrench will achieve a given torque on the load. The tool used was the above-mentioned CP733 together with a standard oil-pressure chamber torque calibration unit. This unit comprises a nut and bolt which are tightened up on an oil-filled chamber the pressure in which is measured as representing the applied torque. The bolt head is drive by the tool with the aid of an adapter as shown in FIG. 1. The CP733 tool was supplied with 6 Bar of air-pressure and was operated in its highest tool-force setting (4) in the forward mode. What has been investigated is the build up of torque during successive impacts in the tool and how the insight gained leads to practical measures that can be used in a predictive fashion to control operation of the tool.

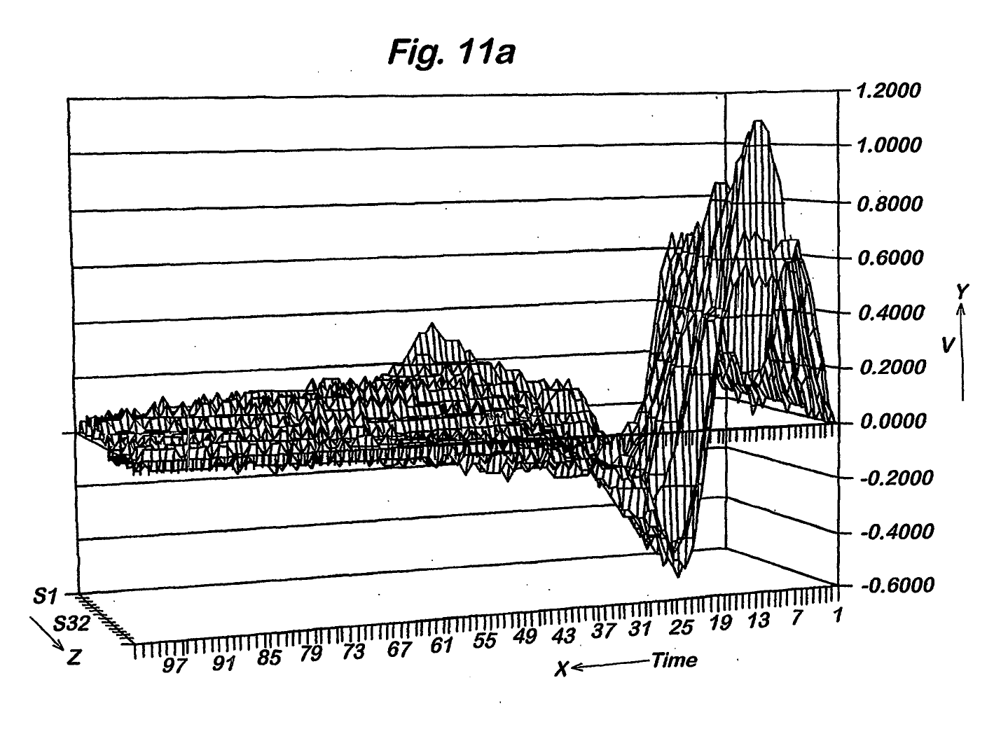

In using the tool and in some of the graphs referred to below, account needs to be taken of the effect of the mechanical adapter (20 in FIG. 1). FIG. 10 shows superimposed curves representing a series of torque impulses such as 120. Each pulse is two superimposed pulses, the one 122 on the right relating to driving a load without an adapter: the other 124 on the left is driving a bolt head through an adapter, the tool being secured in a jig to eliminate hand-held variation. Nonetheless it is seen that whereas the pulses on the right are of essentially constant peak positive amplitude, those on the left show a significant range of positive peak amplitude and tend to vary in a cyclic manner. These variations may be due to the lose mechanical fittings between the output shaft of the tool, the adapter and the bolt head; and varying recoil forces from impact to impact.

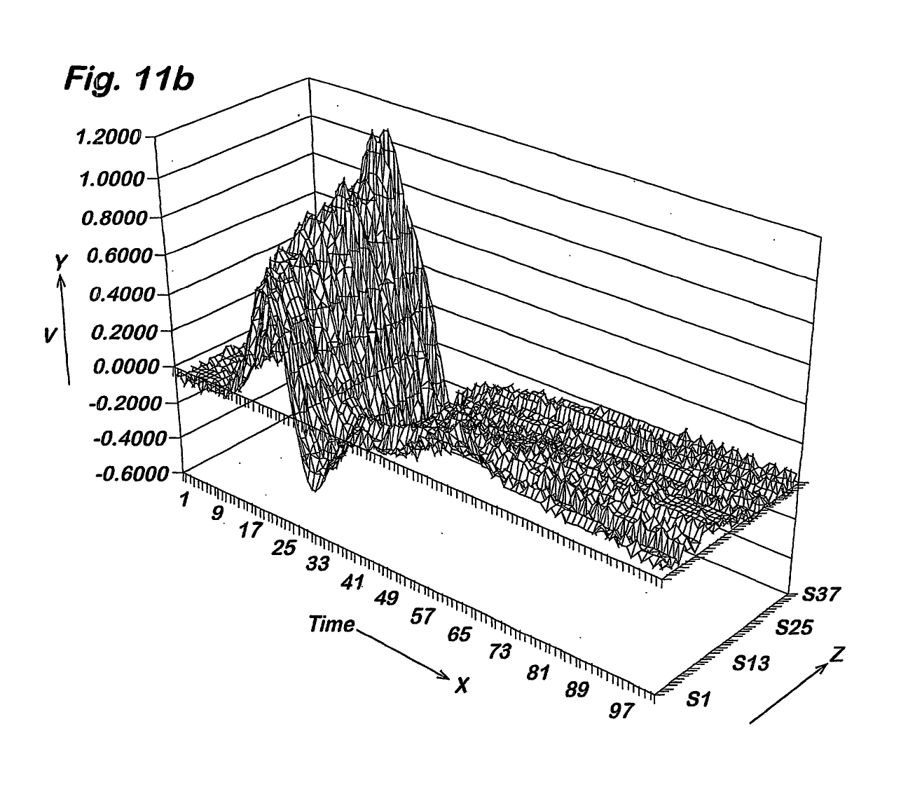

Reverting to the explanation of the nature of torque impulses with reference to FIG. 6 and the investigative support for the explanation given with reference to FIGS. 7 to 9, the results of a whole series of sequential impacts is seen in FIGS. 11a, 11b and 11c which show the same data presented in three-dimensional graph from but from different perspectives. These figures relate to data from the magnetic torque transducer in the tool. FIG. 11a shows the results of a sequence of torque impulses S1 to S37 in a Z-direction out of the plane of the paper. Thus the last event is at the foreground. Each pulse extends in time along the X-axis but to the left with a zero time point at the right. The Y-axis shows each torque pulse as measured as a voltage (V) from the magnetic transducer output. FIG. 11b shows FIG. 11a “looking from the rear” with the first event in the foreground and the time axis running to the right. Fib. 11b shows the early pulses have a primary impulse (with rebound) and the distinct secondary impulse (darker) indicative of the bolt head flying ahead as previously discussed. The peak amplitude of the primary pulse is restricted. However as the bolt head tightens the primary impulse rebound disappears. This is at about impact S10 and essentially all the torque impulse energy is dissipated in turning the bolt head and any ancillary losses. As the bolt tightens further the peak positive amplitude of the primary pulse is increasing and the rebound portion of it reappears. At this stage the progress is better seen in FIG. 11a which shows the peak achieving a maximum value as the bolt approaches the hard tight state. However, it will be seen from FIG. 11a that at the very last impacts the peak amplitude drops which may be due to the head in fact turning a little more.

Referring now to the presentation of FIG. 11c, this shows that sequence of impulses S1-37 looked at “end-on” and looking toward time zero. The events are on the X-axis, time is in the Z-axis with time zero being in the background and the Y-axis is again the signal amplitude. What can be seen is that the output signal is generally increasing through the sequence of inputs save for the sudden drop at the end already noted. Time t is in units of 40 μS.

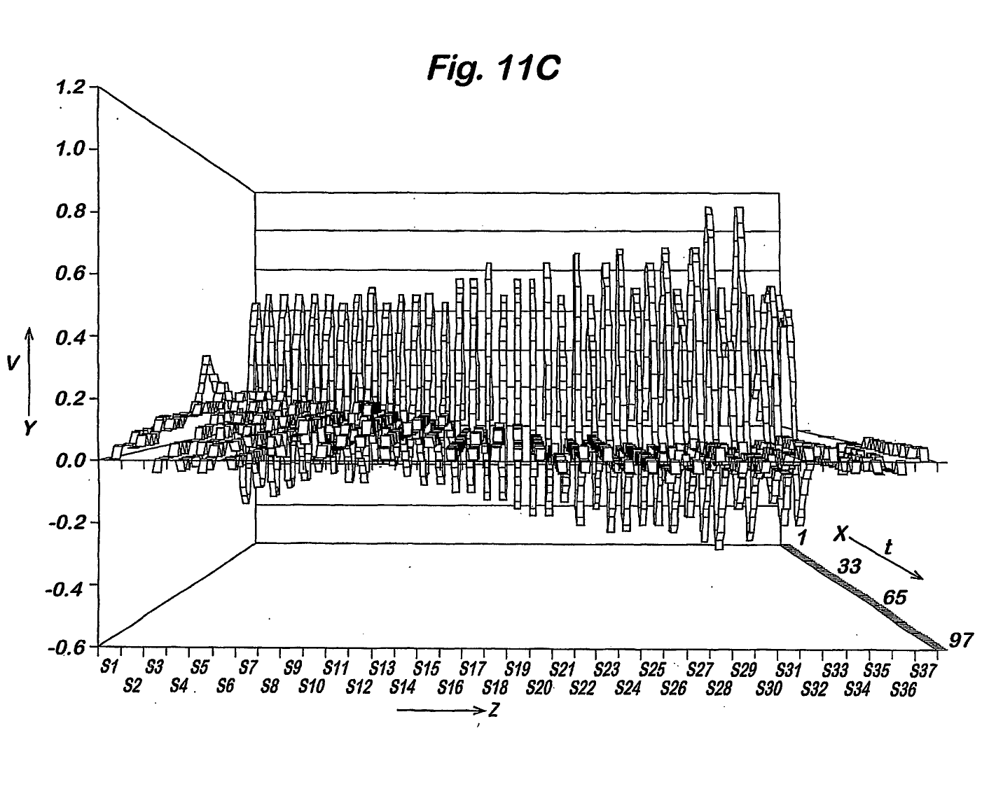

The data presented in FIGS. 11a-11c is used in a manner that will be described below particularly relying on the increase in the peak amplitude over the series of inputs. However, before describing this further attention is drawn to FIG. 12 which is presented in the same manner as FIG. 11 and shows a sequence of impulses which is at a substantially constant peak pulse amplitude. Nonetheless torque on the bolt-head is increasing during the sequence. If such a case is detected, operation of the tool is predicted or measured in a different manner as will also be described.

The procedures for deriving control signals or commands for the operation of the tool will now be described. They fall under the two heads earlier mentioned, namely “Signal Integration” and “Instantaneous Torque Calculation”.

It has been found that whether bolt tightening proceeds according to FIGS. 11a-c or to FIG. 12 depends on the condition of the bolt in the fixture (FIG. 1). Where the bolt is well greased so that tightening proceeds smoothly, the FIG. 11a-c characteristic is more likely to apply. Where the bolt is for example rusty and binds, the pulse characteristic of FIG. 12 is more likely.

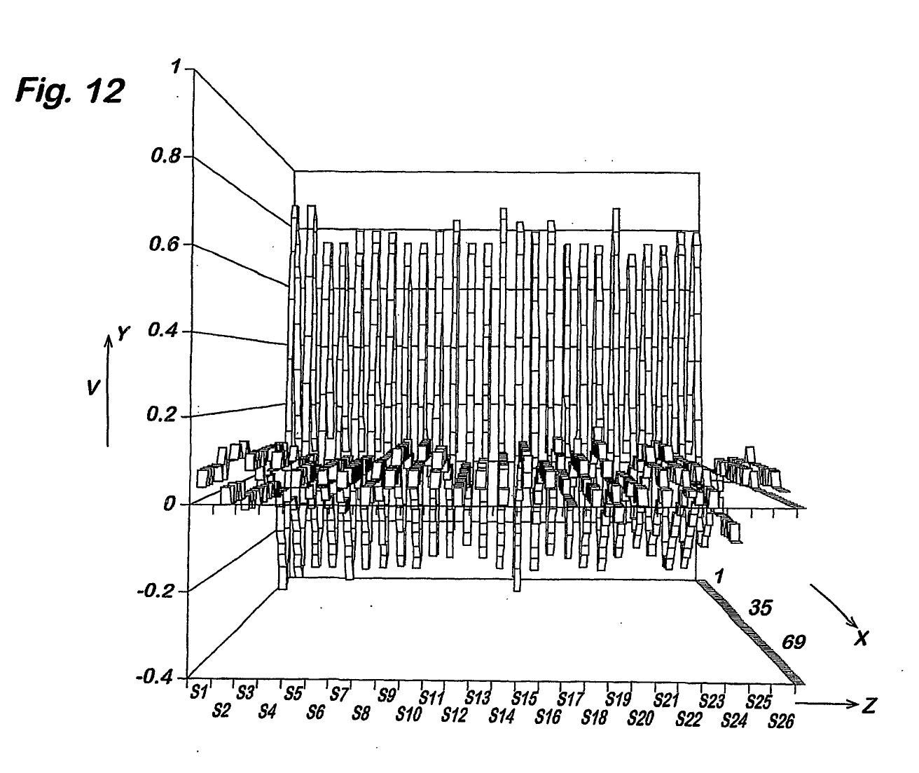

The Instantaneous Torque Calculation involves manipulating the data of the recorded torque impulses to best fit a curve of a form described below with reference to FIG. 13. However, this curve fitting technique may not apply in cases, such as that of FIG. 12, in which the positive peak of each successive torque impulse remains essentially constant. The Signal Integration procedure can be used for such a case and will be explained first before going on to the Instantaneous Torque Calculation procedure.

1) Signal Integration

First of all it will be recalled from FIG. 6 that it is postulated that a impact pulse may comprise a primary pulse and a secondary pulse as shown in FIG. 6A and that as the bolt tightens, the secondary pulse advances in time with respect to the primary pulse until they merge. Once the bolt tightens significantly (no longer flies ahead), a torque pushing mode is entered as illustrated in FIG. 5. The period of the positive portion of the primary pulse remains much the same. FIG. 12 illustrates circumstances in which the pulse positive peak value is near constant.

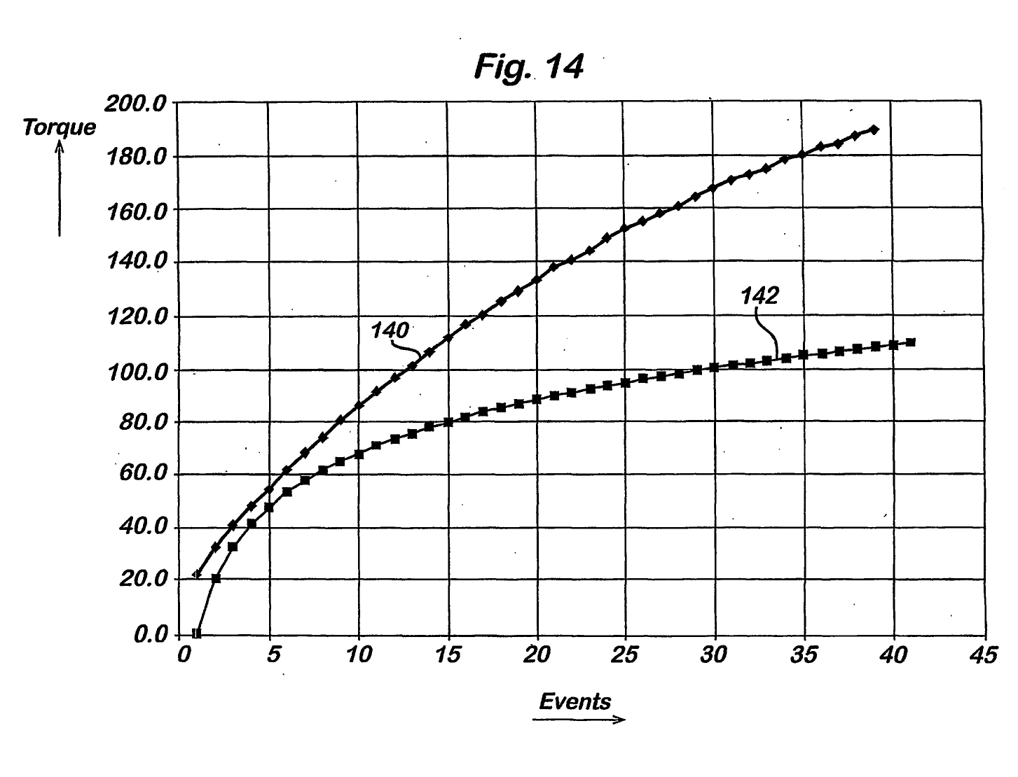

FIG. 13 shows a graph in which curve 130 shows an integration or summation of the positive peak torque pulse value (ordinate). It proceeds in a step-wise fashion per impact. As will appear below with reference to FIG. 15 the impact rate remains relatively constant over a train of impulses at 17-20 impacts/second for the tool investigated so the step-wise curve 130 may be expressed in terms of time as is the case in FIG. 13. The integrated value on the ordinate axis is calibrated to relate to torque values so that, the tool can be controlled for a pre-determined number of impacts or for a pre-determined time for a desired torque to be achieved. In processing the positive pulse portions it is desirable to set a threshold which the pulse must exceed to be recognised.

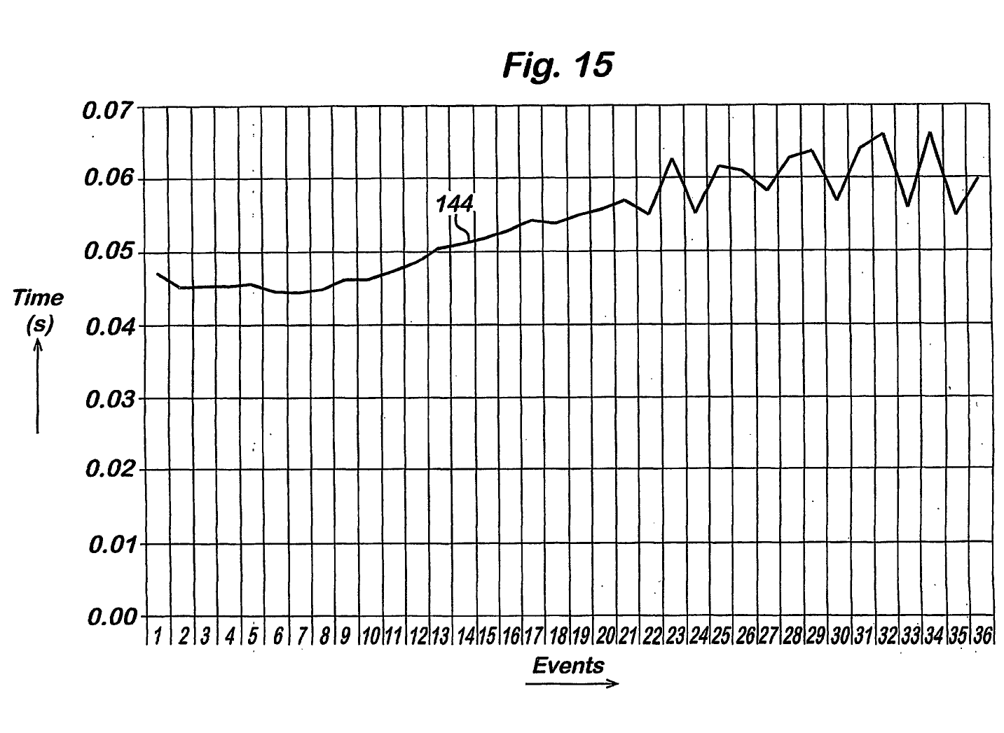

Another possibility is to integrate each pulse over its positive portion as is done in the Instantaneous Torque Calculation procedure described below. This is effectively the area under the positive pulse curve—see FIG. 16. The individual pulse integrals or areas are then themselves integrated summed.

It has been found that the rate of rise (slope) of curve 130 in FIG. 13 is dependent on the air pressure in the tool. The higher the pressure the greater the rate of rise but the curve remains generally semi-logarithmic as shown.

By way of comparison FIG. 13 also shows the signal integration applied to the absolute value of the negative (rebound) portions of the impulses. This is curve 132. It still rises with the increasing number of impacts but the curve generated is not as regular as using the positive pulse portions. It is found generally that the rebound pulse portions tend to be more erratic from impact-to-impact. The time values on the abscissa are in increments of 40 μs.

2) Instantaneous Torque Calculation

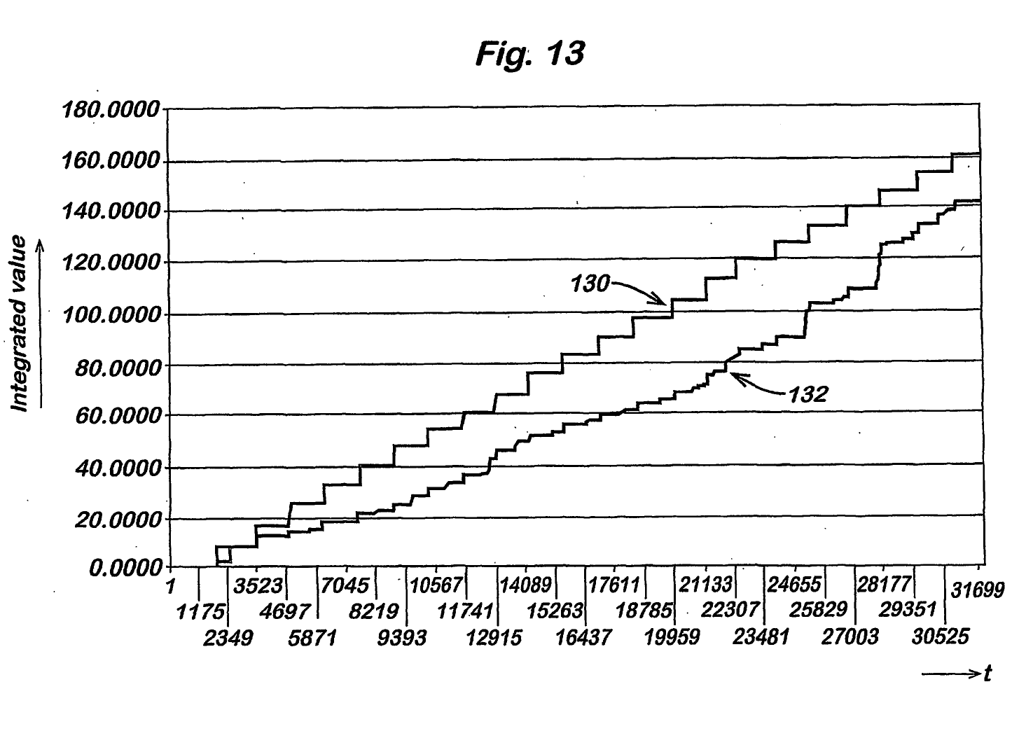

The starting point for the procedure to be described is the curve of FIG. 14. FIG. 14 shows a typical curve 140 of the torque exerted as a function of the number of impacts. It is seen that the torque rises in a non-linear fashion, rising relatively rapidly for an initial number of impacts but the torque increase per impact is showing all the time. Eventually the curve would become asymptotic towards a maximum torque value. Practicability requires that the tool should be operated within this maximum torque rating such that a desired torque is reached reasonably quickly. The shape of the curve of FIG. 14 is generally applicable as a model or template. It can be stored as an algorithm defining a semi-logarithmic relationship of torque to the number of impacts. What will be described below is how actual torque pulse measurements can be fitted with the curve to provide a prediction or measure of the number of impacts or the time required to obtain a desired torque.

For comparison, FIG. 14 also shows a second curve 142 which is of the same general shape as curve 140 but arising from a poor air source. The curve 140 pertains to a high, stable air-pressure (e.g. well buffered) at a steady 6 Bar, while curve 142 pertains to a lower, unstable air-pressure (e.g. poorly buffered) at 5 Bar. The maximum torque attainable on curve 142 is less than that on curve 140. The impacts (events) were at a rate of 17.20 per second.

The torque expressed in FIG. 14 was measured via a use of an oil-filled chamber as mentioned above. For the present purposes the curve 140 can be regarded as at model or template defining the build-up of torque with the numbers of impacts (uninterrupted sequence), though it is subject to scaling.

FIG. 15 is a graph of the impact rate, that is the impact interval through the sequence of impacts plotted as curve 144. As can be seen the interval generally increases over the sequence but not greatly. This is referred to below.

What has been found to be a very important parameter relates to the shape and duration of the individual pulses as seen in FIG. 16. The figure diagrammatically shows a sequence of three pulses 150, 151, 152, diagrammatically exemplified as being of the same shape and having equal characteristic parameters. Each pulse has the form discussed previously (see FIG. 6) with an initial positive portion 154 followed by a rebound portion 156 of opposite polarity. The interval between impacts (as used in FIG. 15) is indicated as tₑ, and the duration of the positive portion of a pulse as tₚ. The total pulse duration is denoted tₜ. For each pulse further characteristics can be derived from the variation of pulse amplitude with time. These are
PAₚ: the area of the positive pulse as indicated for pulses 151 and 152 and which in an integral of the pulse curve with time.
PAₙ: the area of the negative or rebound portion of the curve as indicated for pulse 152.

What has been found to be of particular interest is a factor which is obtained by multiplying each positive pulse area by its duration, namely PAₚ×tₚ. It is to be noted that, in cases where a distinct secondary pulse occurs (FIG. 6A), this multiplication applies to the primary pulse. The secondary pulse can be distinguished in processing a train having both by a gating process based on the a priori knowledge that the interval tₑ from one primary pulse to the next is much longer than that between a primary pulse and associated secondary pulse.

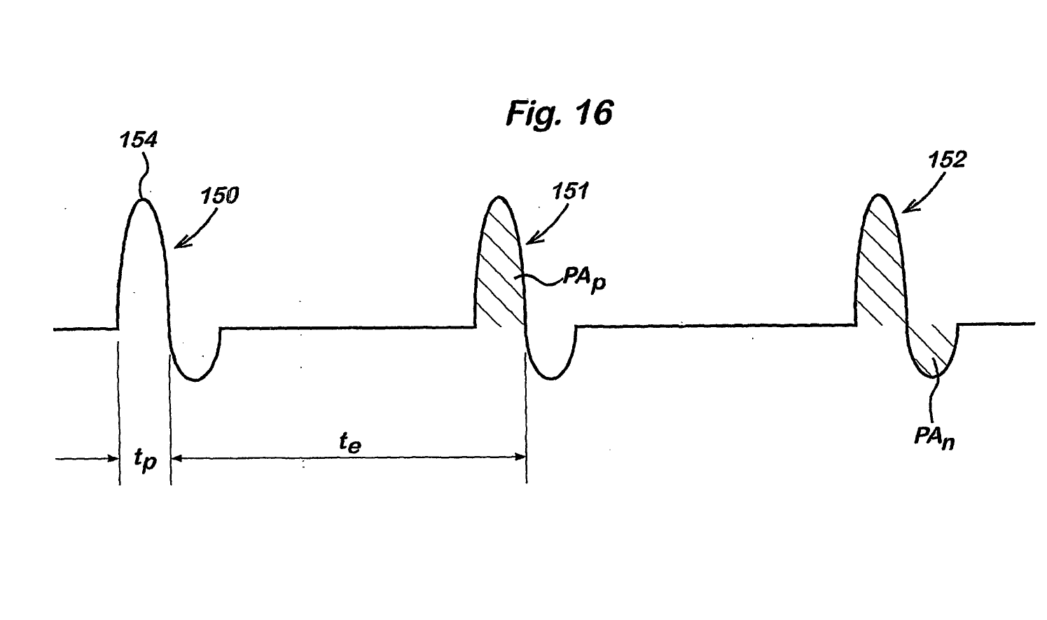

Investigations have shown that it is advantageous to rely on the positive torque pulse portions only. The inclusion of negative (rebound) pulse portions does not lead to a clear correlation with the template curve 140 of FIG. 14. As already noted, the rebound pulses tend to be far more variable than the positive torque pulses. Data obtained for a sequence of impulses will now be given by way of the graphs of FIGS. 17-19. It will be apparent in all the curves shown (which are in fact event-by-event plots) that there is considerable pulse-to-pulse variation. The impulses are generated in a sequence generally of the form of FIGS. 11a-11c.

FIG. 17 shows curves 160 and 162 both plotted as a function of the impact number of a train of impacts increasing to the right. Curve 160 shows the positive pulse width tₚ per impact (left-hand ordinate axis). Curve 162 shows the positive pulse area per impact (arbitrary scale on right-hand ordinate axis). The pulse width increases relatively rapidly at first (this may be associated with a distinct secondary pulse). The pulse width then increases at a lesser rate where the pulse forms and durations are nearer to being seen as in FIG. 5.

On the other hand the positive pulse area PAₚ per impact increases little initially and then far more rapidly, though its pulse-to-pulse variations are greater than those of the pulse width and become out-of-phase with them as is clearly seen on the right of the graph.

It is to be noted in FIGS. 17-19 that in comparison with the control exercisable in the pendulum laboratory apparatus, the measurements now presented are in a rapidly rotating machine. One factor in the machine is that there is not only an impulse delivered by a striking hammer but there is a reaction on the hammer introducing a bounce into its travel and timing.

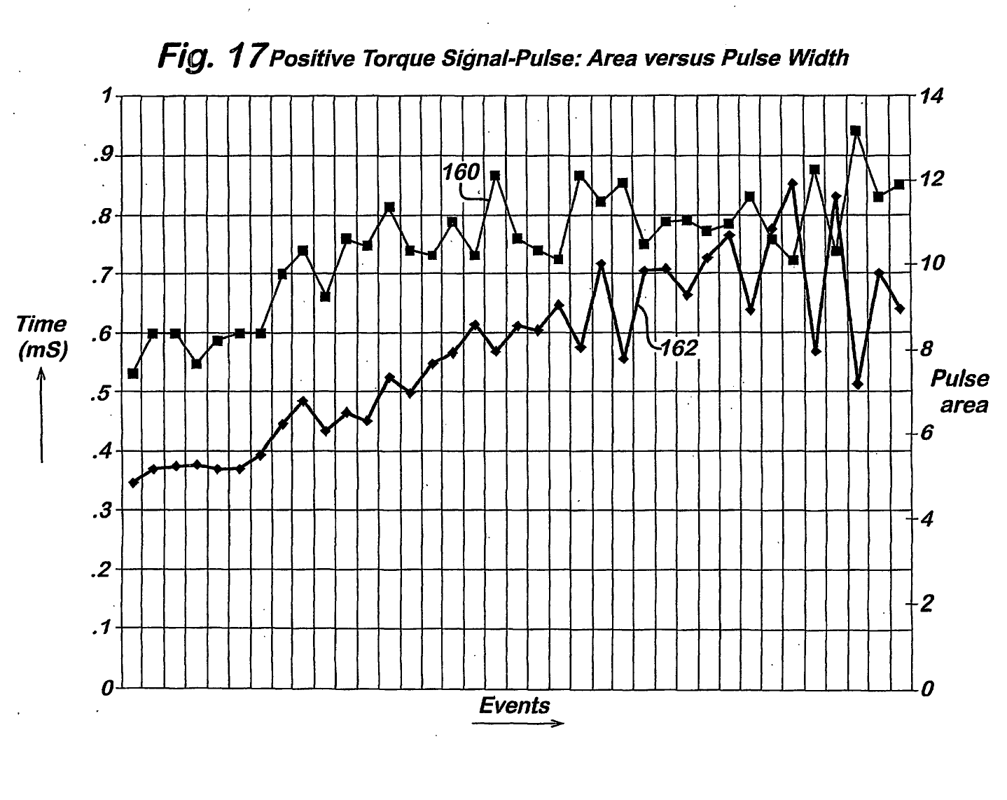

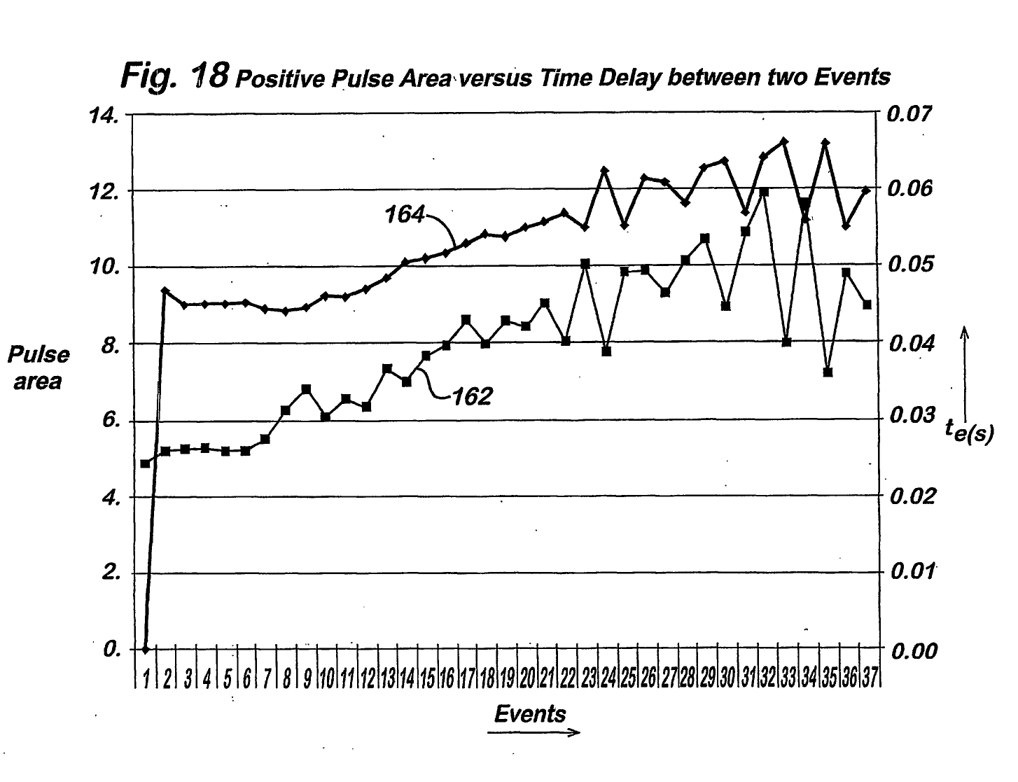

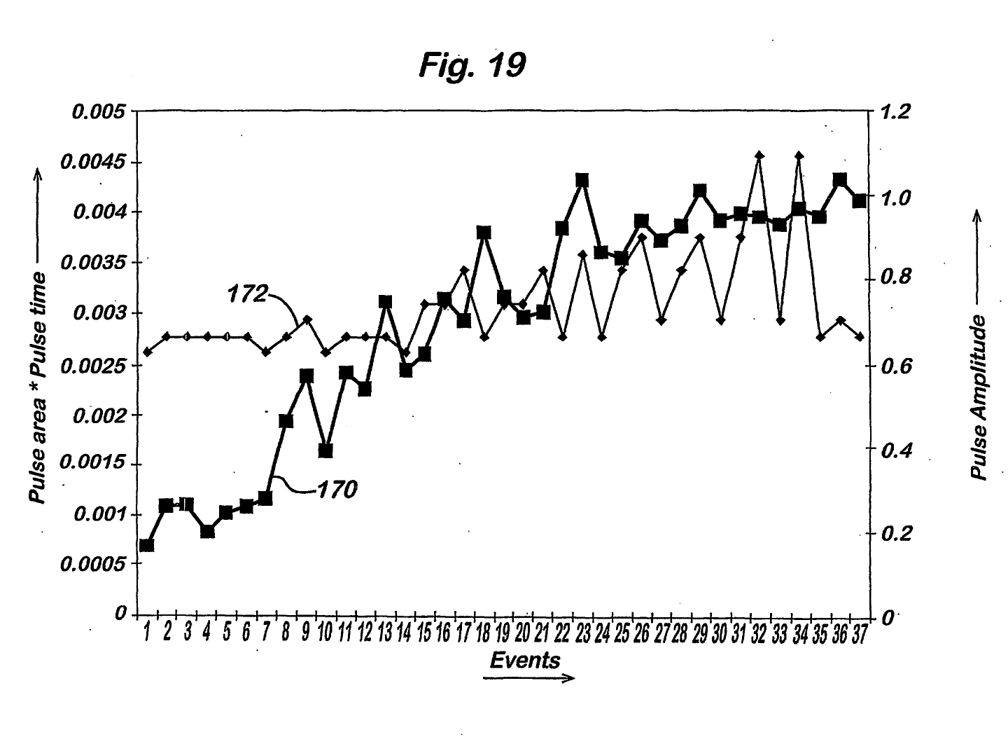

FIG. 18 again shows curve 162 this time plotted in conjunction with a curve 164 which is the interval between successive pulses (tₑ in FIG. 16). Of more interest and considerable importance are the curves plotted in FIG. 19. Curve 170 (heavier line) is a combination of curves 162 (FIGS. 17 and 18) and 160 (FIG. 17), namely a value given by pulse area multiplied by time, the value being expressed in units shown on the left-hand ordinate axis. Also plotted for comparison is curve 172 of the positive pulse peak signal amplitude (i.e. no integration of the pulse)—see right-hand ordinate scale. No correlation can be seen between curve 172 and the curve 140. However, the shape of curve 170 does show such a correlation as is seen in FIG. 20 in which curve 170 is replotted (squares) against the template curve 140 (triangles) of FIG. 14. The correlation between the two is evident. The plot of curve 170 has been subject to some filtering during signal processing but curve 140 is not derived by a best-fit procedure. It has been found that the use of the real-time calculated points of curve 170 are sufficient to control a torque-impact tool within the limits required in normal industrial use.

The techniques and procedures described above for processing the impulse torque signals can be implemented in computer programs. Curve fitting procedures and algorithms for defining curves are well-known. The curve such as 140 for a given tool operating under specified conditions can be generated from a general algorithm defining the curve adjusted to specific parameters of the tool in question. Whatever procedures are used, the program(s) can be stored in firmware and performed by a microprocessor or microcontoller with appropriate memory capacity. The facilities provided can also include the ability to learn and store the control data required for a particular task. Thus it is contemplated that all the electronics be mounted with the tool as indicated at 36 in FIG. 1. The electronic circuit will then issue the required commands to control operation of the motor 14.

The foregoing specific description has been given in relation to impact torque tools in which the successive impacts give rise to torque pulses or impulses as has been described. The magnetic transducer technology can also be applied to another type of pulse torque tool which does not rely on impacts to generate pulses but includes means for generating controlled pulses in a train. The Signal Integration procedure can be applied to such pulses and the Instantaneous Torque Calculation adapted to such pulses. One such other type of pulse torque tool uses a piston and cylinder mechanism which is continuously coupled to the output shaft. Pressure pulses are generated in the piston and cylinder mechanism and are transmitted to the shaft.

The foregoing description has discussed the effect of the nature of the load on the pulse generation. Another factor which is also of relevance is the weight (mass) of the output shaft of the tool and the adapter connected to it. Investigation has been made of the loss of torque in transmission of torque pulses along a shaft and this is further discussed below under the heading “Torque Loss Measurement”. A torque pulse applied to the input end of the shaft has the affect of winding (angularly rotating) the input end which winding has to be transmitted along the shaft if torque is to be achieved at the far, load end. The subsequent description discusses torque loss along the shaft and the effect of the form of the torque pulses on the efficiency of transmission. The mass of the shaft and adapter has been found to be a factor possibly due to the local inertia of the shaft and adapter which the propagating torque pulse has to overcome.

There has been described above how the cumulative effect of a torque pulse, and particularly the pulse area×pulse time product, can be used to determine when a predetermined torque is reached at the load under what has been called the Instantaneous Torque Calculation procedure and with particular reference to FIG. 20. Alternatively when a pulse train becomes a series of near constant amplitude pulse a Signal Integration procedure can be employed as particularly described with reference to FIG. 13 and FIG. 15.

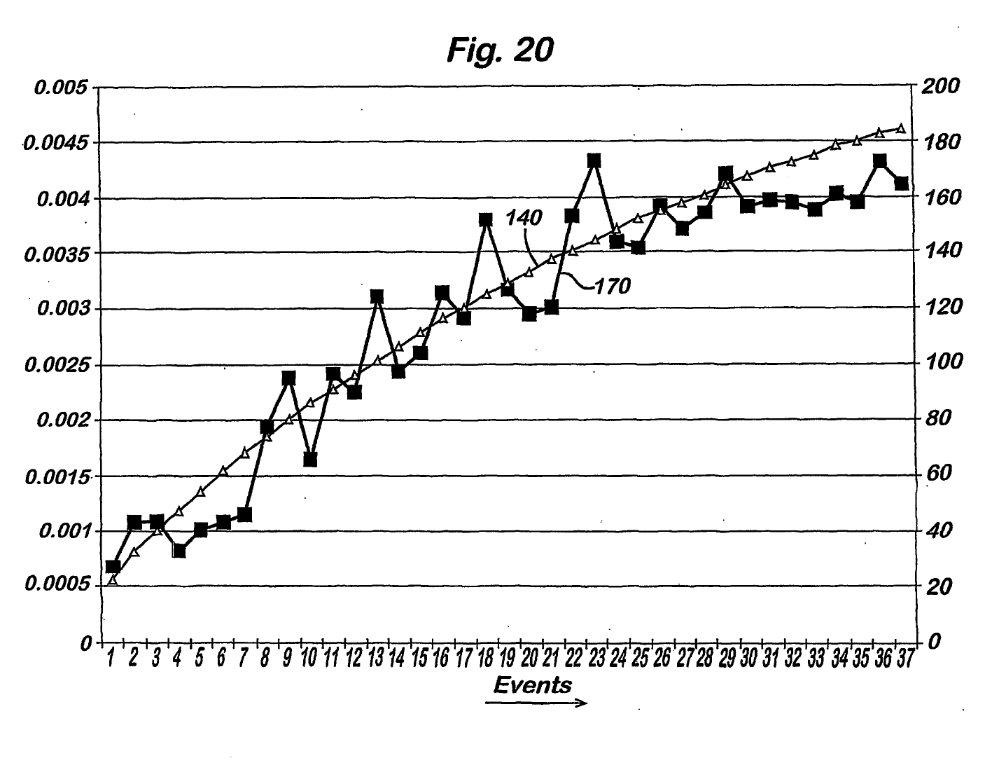

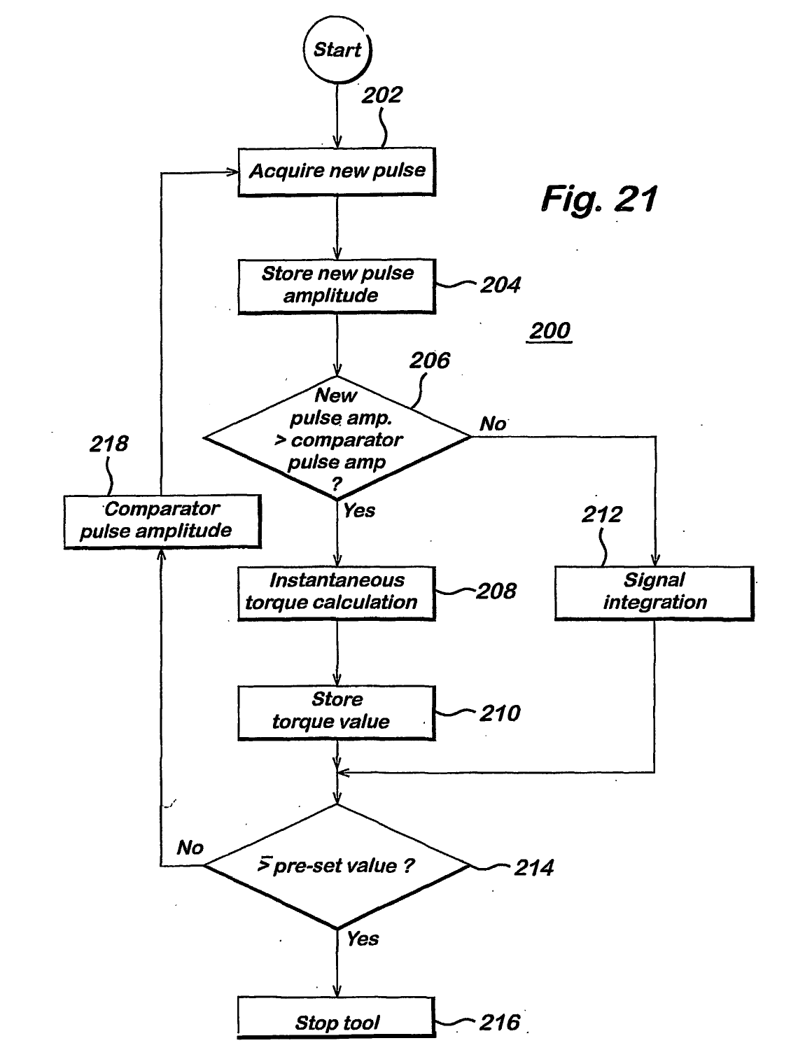

FIG. 21 shows a flow diagram for a procedure for deciding which of the two signal processing applications is to be applied and the manner of so doing. FIGS. 22a and 22b exemplifies show the decision procedure is performed.

Referring to FIG. 21 it illustrates the decision making process 200 applied to a train of pulses detected by the transducer 30 of FIG. 1. The train of pulses is shown in FIG. 22a which shows a representative sample of pulses. As will be clear from the pulse trains given earlier, the actual number of pulses is large in achieving a desired torque.

Each fresh pulse acquired at step 202 has its amplitude entered in a memory store or register at step 204. The pulse amplitude is then compared at step 206 with the preceding pulse amplitude held in a comparator register 218 to decide whether it is part of a rising curve of pulse amplitude or is to be considered a part of a curve of substantially constant amplitude. Because of pulse-to-pulse variations the decision is not necessarily made on the basis of just two next following pulses but by assessing the amplitude of the newly acquired pulse relative to an amplitude value derived from more than one immediately preceding pulse to judge the trend in the pulse amplitude curve.

If the decision at step 204 is that the new pulse is of greater amplitude according to a predetermined criterion, it is processed according to the above Instantaneous Torque Calculation procedure at step 208 and the resultant torque value is stored at step 210. On the other hand if the decision at step 204 is that the new pulse is not of greater amplitude, that is the pulse is one of a series of essentially constant amplitude pulses, it is processed according to the above signal Integration procedure at step 212 adding another increment to the output torque value stored at step 210. It may be that step 206 only provides a decision or a change of decision after a given number of pulses in which action under steps 208 and 212 is then applied to a number of pulses preceding and including the new one using the values stored at step 204.

The process shown in FIG. 21 allows processing of a pulse train according to each of step 208 and step 212 at different stages in the pulse train. FIG. 22a shows a series of pulses which up to pulse N are subjected to Instantaneous Torque Calculation as shown by the semi-logarithmic (exponential) form of the initial portion 220 of the curve of FIG. 22b which represents the value stored at step 208. Thereafter, the decision is to proceed by Signal Integration leading to the substantially linear portion 222 of the curve of FIG. 22.

Reverting to FIG. 21, the torque value stored at step 210 is compared at step 214 with a predetermined or pre-set torque Ts. If the pre-set torque has been reached a command 216 is issued for stop the power torque tool or at least the transmission of generated pulses to the load. If the torque is less than the desired pre-set value the torque pulsing of the load continues, with the comparison register set to the value stored in register 204 or a value derived from it and a number of preceding pulses.

The description thus far has assumed the power torque tool is of the impact type. However, where the context clearly refers to impact torque impulses, the description of pulse processing procedures given above, including with reference to FIGS. 21-22b, applies also to the pressure type of impulses referred to earlier.

The teachings of the invention as regards torque loss measurement are applicable to torque pulses, however generated and however measured. The description given below will be in the context of impact or pressure pulses generated in a power torque tool and measured by use of the magnetic based technology described above.

It will be recalled that FIG. 1 diagrammatically shows a power torque tool in which a single magnetic-based torque transducer is employed. The torque tool 10—also referred to as a torque wrench—is illustrated in FIG. 1 as a hand-held implement having a housing 12 within which is an electrically or pneumatically powered motor 14. Pneumatic power is more usual. The motor is coupled by converter 16 to an output shaft 18 the distal end of which carries an adapter 20 engageable with the load to which torque is to be applied. In this example, the load is a bolt 22 which carries a nut 24 and which extends through an apertured fixture 26. As shown the nut and bolt are being tightened on to the fixture 26. The adapter 20 engages the head 28 of the bolt, being formed with an internal recess that matches the head 28, e.g. an hexagonal head. The features of the tool 10 so far described are conventional and well-known to those in the art. By means of the converter 16 the rotation of the motor 14 is converted to a train of torque pulses in the shaft 18 and those pulses are transmitted to the bolt head 28. The converter may be an impact type of mechanism generating a train of impact pulses or a pressure type of mechanism generating a train of pressure pulses as has been outlined above.

As has been described, a new feature of the tool of FIG. 1 is the employment of a magnetic transducer 30 by which the torque impulses in the shaft are detected and measured. The transducer comprises a torque-sensitive element 32 which is an integral region of shaft 18 which is assumed to be of ferromagnetic material. The region 32 is magnetised to have remnant or stored magnetisation so that it acts as a source of external magnetic field, the magnetisation being effected in such a way that the region 32 emanates a magnetic field or field component which is dependent on the torque. The forms of magnetisation that may be used are set out above. As previously indicated the present invention has been developed using a profile shift magnetisation kind of transducer element. The emanated torque-dependent magnetic field is detected by a non-contacting sensor arrangement 34 which is connected to a detector and control circuit 36 which in turn controls the operation of the motor 14. The sensor arrangement may comprise more than one sensor device, preferably saturating core device(s) connected in a circuit such as disclosed in WO98/52063. Sources of further information on sensor devices are given above.

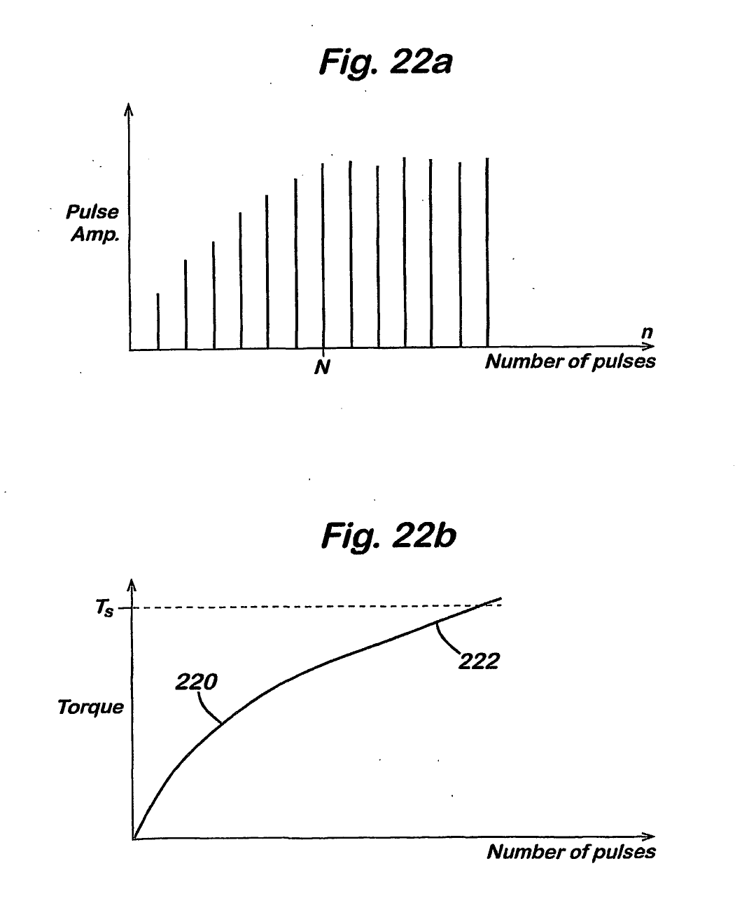

It has been found that using an impact torque tool as an example of the tool illustrated in FIG. 1 that the impulses measured with the aid of transducer 30 are irregular in both pulse spacing and in amplitude which may be due to reaction or bounce of the hammer with respect to the anvil sometimes leading to a double impact. It is difficult to predict the moment at which a desired torque is achieved at bolt-head 28. FIG. 23a diagrammatically illustrates the sharp spiky nature of impact pulses and their irregularity in time and amplitude.

If the tool illustrated in FIG. 1 is of the pressure mechanism type producing pressure pulses, it has been found using the transducer 30 that the train of pulses generated is more regular and the individual impulses are of longer duration than impact pulses (it is noted here that in the art impact power tools have been simply referred to as such, while what is referred to herein as pressure power tools have often been referred to as impulse torque tools). For comparison FIG. 23b diagrammatically illustrates the generation of the smoother more regular pressure pulses.

Investigation has now shown that in transmission along the output shaft 18 of a power torque tool, the energy of impact pulses is absorbed and dissipated far more rapidly than is that of pressure pulses. The mechanism of torque transmission along a shaft to a load whose characteristics vary as tightening proceeds is not easy to define and analyse.

The following is put as a consideration of factors involving the transmission of a torque pulse applied at the input end of the output shaft 18 to the far, load end of the shaft.

Consider first a continuous torque being applied—which may be thought of as analogous to D.C. energisation of an electrical transmission system. The shaft is wound about its axis by applied torque so that the shaft itself both absorbs energy and stores it in the resilience or elasticity of its material. This winding action is propagated along the shaft and with the continued torque applied at the input end, torque is eventually delivered at the load end. The loss along the shaft is a linear function of distance along the shaft.

Turning now to pulsed torque, to use the electrical analogy, this may be considered a case of A.C. pulse propagation, though substantially a unipolar A.C. case. A pulse of torque applied to the input end of shaft 18 but as the shaft winds under the applied torque, the torque ceases in the pulse interval so that there is no continuing torque to ensure further winding propagating along the shaft. Stored energy may cause relaxation of the shaft. The investigations made to date indicate that the short pulses of FIG. 23a are less likely to cause an effective torque pulse to propagate along the shaft due to losses and elastic rebound. Whatever, the reason the short impact pulses tend to dissipate relatively rapidly.

In contrast the longer duration pulses of FIG. 23b have been found to be more effective in propagation along the shaft and developing torque at the load end. It has been found that the area under the pulse is important to the torque developed at the load. It is surmised that a higher mark/space ratio is advantageous—that is pulse duration/pulse spacing.

The pulses illustrated in FIGS. 23a and 23b are much simplified. It is known that the impact pulses of FIG. 23a are more complex in reality and that their shape will change with the state of tightness of the load. Also of potential relevance to this is to what extent the impact pulse generator “sees” the load which becomes more remote, the longer the transmission shaft.

Another factor that has been found to be relevant is the weight or mass of the shaft which is to transmit the shaft together with the mass of the adapter coupled to the end of it. Current investigation suggests the lower the mass, the greater the efficiency of torque propagation. A mass-related parameter that may relate to the finding is that the progressive winding of the shaft, and eventually the shaft plus adapter at the far end, also entails overcoming the local inertia of the shaft.

Whatever the underlying theory of the transmission of torque pulses along a shaft, there remains a general need to be able to investigate the pulses transmitted and to be able to obtain some measure of the losses entailed in transmission.

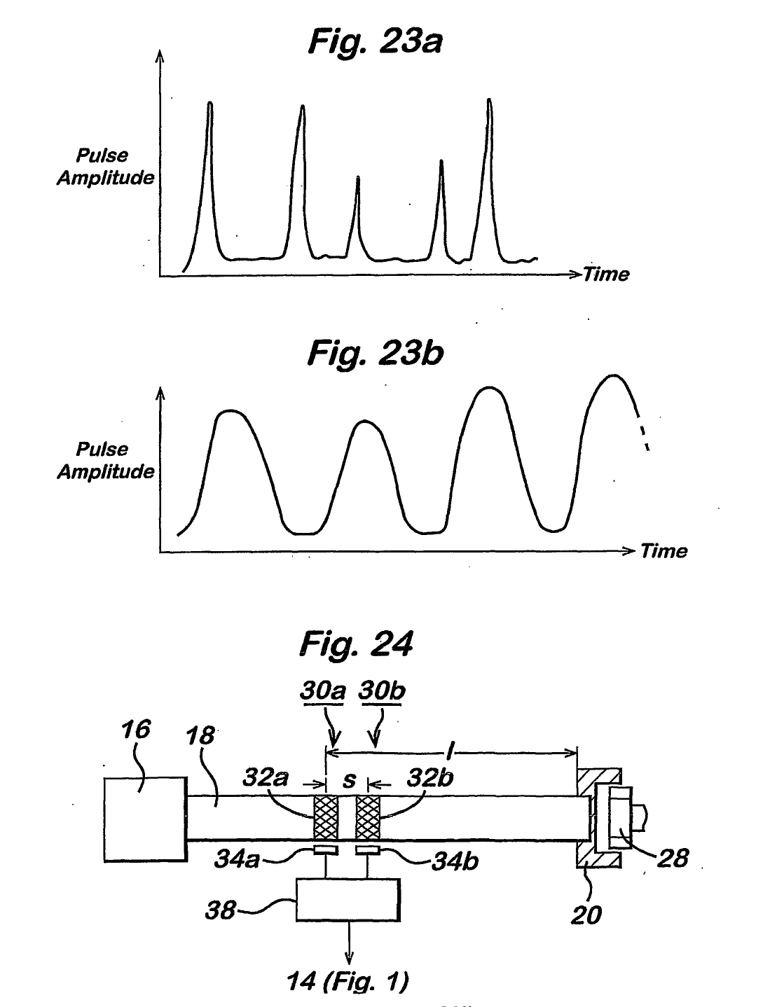

FIG. 24 illustrates an embodiment of the transducer arrangement of the present invention. It shows a torque pulse converter 16 coupled to an output shaft 18 terminating in an adapter 20 engaging a bolt head 28 as in FIG. 1. In FIG. 24 two transducers 30a and 30b are utilised each of the same kind as transducer 30 in FIG. 1. In FIG. 24 the signals from respective sensor arrangements 34a and 34b are processed by signal processing unit 38 which may be realised in hardware and/or software. The respective transducer regions 32a and 34a are spaced apart along the shaft by a distance s. If the torque as measured at sensor arrangement 34a is Ta and that as measured at sensor arrangement (34b) is Tb, any torque loss T_{L} in transmission of a torque pulse along the shaft between sensors 34a and 34b is given by:
T_{L}=Ta−Tb
and the rate of loss R_{L} expressed as loss or dissipation per unit distance along the shaft is
R_{L}=(Ta−Tb)/s.

It is assumed that over the spacing s, the rate of loss R_{L} can be taken as a constant per unit length. In the first example given below the loss or dissipation per unit length is taken to be constant along the length of the shaft. If this does not apply s should be a sufficiently short increment of distance that the value of R_{L} can be used in calculating the torque loss over the length of the shaft to the load. In a test power tool according to the embodiment of FIG. 24, the spacing s was 15 mm.

The rate of loss R_{L} expressed as loss or dissipation per unit distance along the shaft is
R_{L}=(Ta−Tb)/s

If the dissipation is constant then at a distance l to the load from sensor arrangement 34a total loss T_{T} is given by
T_{T}=l.(Ta−Tb)/s
and the torque delivered, Tr, from the shaft is given by
Tr=Ta−l(Ta−Tb)/s.

This expression is likely to be less true the shorter the pulses become, as with impact pulses. It will be understood that the same arrangement of two spaced transducers can be employed even if the dissipation is not a constant absolute value. For example if the dissipation is akin to an attenuation expressed as a fractional or percentage loss per unit distance, the dissipation of loss factor, D, can be determined as
D=(Ta−Tb)/(Ta.s).

In this case the decline in torque delivered is exponential with distance and the torque delivered can be expressed as
Tr=Ta.e^{-lD}.

This expression of the torque loss is a form familiar from the transmission of A.C. electrical signals to return to the electrical analogy given above. It may be that the expression to be used is somewhere between the A.C. and D.C. cases. It may thus be important to know the form of torque pulses being transmitted at any moment. A magnetic torque transducer of the kind referred to herein enables the pulse train and its waveform to be analysed. Such facilities and functions can be provided in unit 38.

By the adoption of a predictive technique of when a required torque is reached at the load based on a measure of torque at a point preceding the load such as torque Ta, the unit 38 can be employed to deliver control signals to the motor 14 (FIG. 1) which are better related to actual load conditions.

It will be also understood that the predictive technique applied downstream of the torque measure to the load end of the shaft can also be applied to the actual torque delivered to the converter end of the shaft.

It will be understood that to determine torque loss and to make predictive calculations from it the measurement of torque at two spaced points along the shaft can be done by transducers other than those specifically referred to above, both magnetic and otherwise. The concept of measuring torque loss along a shaft, particularly for pulsed torque, by torque measurement at two spaced points is considered novel. However, as already mentioned magnetic-based transducers can provide signals which convey a waveform representing the instantaneous value of the torque and which can be analysed for pulse period, mark/space ratio and area under the pulse.

Although the measurement of torque loss has been described in relation to its application to power torque tools, it is considered that the teachings herein are of wider utility in measuring torque transmission by a shaft, particularly where the applied torque is of a pulsed nature and/or the load as such as to require increasing torque to drive the load.

1. A pulse torque tool comprising a transducer assembly for obtaining signals indicative of torque in an output shaft of the tool, wherein
said transducer assembly comprises a magnetised transducer element carried with the shaft to be responsive to the torque therein and supporting a stored magnetisation which emanates a magnetic field or magnetic field component dependent of the torque, and a magnetic sensor arrangement non-contactingly mounted with respect to the output shaft or transducer element to detect the emanated magnetic field and provide an output signal dependent thereon.

2. The pulse torque tool as claimed in claim 1 wherein said transducer element is formed in an integral region of the output shaft.

3. The pulse torque tool as claimed in claim 2 wherein said transducer element supports a stored magnetisation which extends in an annulus about the axis of rotation of the output shaft and which extends in the axial direction.

4. The pulse torque tool as claimed in claim 1 wherein the tool has a housing within which is housed an electronic circuit associated with the transducer assembly to generate a torque representing signal from a train of pulses.

5. The pulse torque tool as claimed in claim 4 wherein said circuit is coupled to a motor for driving the tool to control the operation of the tool.

6. The pulse torque tool as claimed in claim 1 wherein the tool is an impact torque tool.

7. The method for generating a torque-representing signal for the torque generated in a pulse torque tool having an output shaft, comprising the steps of:
a) sensing a train of torque pulses generated in the tool to obtain a train of pulse signals, each pulse signal at least including a pulse portion during which torque is transferred to said output shaft;
b) processing each pulse of said train to derive from said pulse portion of each pulse, a first value representing the time integral of said portion; and
c) multiplying said time integral value for each pulse with the pulse duration of said pulse portion thereof to obtain a second value representing the torque generated in that pulse, whereby a train of second values is derived corresponding to each pulse of said train.

8. The method as claimed in claim 7 further comprising the steps of:
d) applying a train of torque pulses from the tool to a calibration unit acting as a load for the tool;
e) obtaining a calibration curve for the pulse power tool, the calibration curve being a plot of successive measured values of torque in the calibration unit with the successive pulses in the train; and
f) comparing the calibration curve for a train of pulses with the curve of a plot of the second values obtained in step c).

9. The method for applying a train of torque pulses to a load by means of a pulse power tool, comprising the steps of:
1) performing the method steps of claim 1 while the tool is engaged with the load and;
2) applying said train of pulses to the load;
i) until a predetermined second value is achieved in step c), or
ii) for a time commensurate with achieving a predetermined second value.

10. The method as claimed in claim 7 wherein the pulse power tool is an impact pulse tool.

11. The method for generating a torque-representing signal for the torque generated in a pulse torque tool having an output shaft, comprising the steps of:
a) sensing a train of torque pulses applied to the output shaft;
b) comparing the amplitude of a fresh pulse of the train with a comparison amplitude derived from at least one preceding pulse; and
c) if the amplitude of the fresh pulse exceeds the comparison amplitude entering a value calculated from the fresh pulse as an output torque value.

12. The method for generating a torque-representing signal for the torque generated in a pulse torque tool having an output shaft, comprising the steps of:
a) sensing a train of torque pulses applied to the output shaft;
b) comparing the amplitude of a fresh pulse of the train with a comparison amplitude derived from at least one preceding pulse; and
c) if the amplitude of the fresh pulse does not exceed the comparison amplitude, incrementing a stored torque value by a value representing the amplitude of the fresh pulse.

13. The method for generating a torque-representing signal for the torque generated in a pulse torque tool having an output shaft, comprising:
a) sensing a train of torque pulses applied to the output shaft;
b) comparing the amplitude of a fresh pulse of the train with a comparison amplitude derived from at least one preceding pulse;
c) entering a value calculated from the fresh pulse as an output torque value if the amplitude of the fresh pulse exceeds the comparison amplitude; and
d) incrementing the output torque value obtained in step c) or a stored torque value by a value representing the amplitude of the fresh pulse if the amplitude of the fresh pulse does not exceed the comparison amplitude.

14. The torque transmission system comprising:
a shaft rotatably mounted for the transmission of torque along of the length of the shaft from an input and to an output end;
first and second torque transducers located to sense the torque in the shaft at first and second spaced locations between said input and output ends and operable to provide first and second signals representing the torque at said first and second locations respectively; and
output means responsive to said first and second signals to generate an output signal dependent on the difference therebetween.

15. The torque transmission system as claimed in claim 14 wherein said output means is operable to derive from said output signal a value of the torque delivered by the shaft at a location remote from said first and second transducers.

16. The torque transmission system as claimed in claim 14 wherein said output end of the shaft is adapted for coupling to a load to which torque is to be delivered.

17. The torque transmission system as claimed in claim 15 wherein the location remote from said first and second transducers is said output end.

18. The torque transmission system as claimed in claim 14 wherein the input end of said shaft is coupled to torque generating means for delivering torque to the shaft, said torque-generating means being operable to generate a train of torque pulses.

19. The torque transmission system as claimed in claim 18 wherein said torque generating means is operable to generate pulses of the pressure pulse type.

20. The torque transmission system as claimed in claim 14 wherein said output means is input with the spacing between the first and second transducers, and is operable to generate an output signal which represents the difference between said first and second signals expressed as a loss per unit length.

21. The torque transmission system as claimed in claim 18, wherein said first torque transducer provides said first signal as a waveform representing the instantaneous torque detected thereby and said output means is operable to analyse said waveform.

22. A The torque transmission system as claimed in claim 20 wherein said output means is operable to derive said value of torque delivered according to a predetermined relationship expressing torque loss as a function of distance of transmission along the shaft.

23. The torque transmission system as claimed in claim 22 wherein said output means is operable to generate a command signal for said torque generating means upon said value of torque delivered reaching a predetermined value.

24. The torque transmission system as claimed in claim 14 wherein each of said first and second transducers is magnetic-based, each comprising a respective region of the shaft that is magnetised to emanate a magnetic field component that is a function of torque in the region and a respective magnetic field sensor arrangement responsive to the emanated field component, the sensor arrangement not contacting the shaft.

25. The torque transmission system as claimed in claim 14, wherein the system includes a power torque tool.
